(19) United States
(12) Patent Application Publication
(10) Pub. No.: US 2018/0048162 A1
(43) Pub. Date: Feb. 15, 2018

(54) METHODS AND APPARATUS FOR SIGNALING USING HARMONIC AND SUBHARMONIC MODULATION

(71) Applicant: QUALCOMM Incorporated, San Diego, CA (US)

(72) Inventors: William Henry Von Novak, San Diego, CA (US); Linda Irish, San Diego, CA (US); Seong Heon Jeong, San Diego, CA (US)

(21) Appl. No.: 15/675,531

(22) Filed: Aug. 11, 2017

Related U.S. Application Data
(60) Provisional application No. 62/375,393, filed on Aug. 15, 2016.
(60) Provisional application No. 62/375,397, filed on Aug. 15, 2016.

(51) Int. Cl. H02J 5/00; H02J 7/02; H04B 5/00; H02J 50/12

(52) U.S. Cl. CPC H02J 5/005; H02J 50/12; H02J 7/025; H04B 5/0037

(57) ABSTRACT

An aspect of this disclosure is an apparatus for receiving power wirelessly. The apparatus may be characterized by an impedance comprising a resistive component and a reactance component. The apparatus comprises an antenna circuit configured to receive power from a wireless charging field generated by a power transmitter, and to communicate with the power transmitter via a reflected signal, the reflected signal having a fundamental frequency. The apparatus may further comprise a control circuit coupled to the antenna circuit to generate the reflected signal. The reflected signal may be generated by performing at least one of: varying the resistive component of the impedance to generate a signal in the reflected signal having a frequency less than the fundamental frequency; and varying the reactance component of the impedance to change a phase of the reflected signal.

### CROSS-REFERENCE TO RELATED APPLICATIONS

This application claims the benefit of U.S. Provisional Application No. 62/375,393, filed Aug. 15, 2016, and U.S. Provisional Application No. 62/375,397, filed Aug. 15, 2016, both of which are hereby incorporated by reference under 37 CFR 1.57.

### BACKGROUND

### Field

The present disclosure relates generally to wireless power transfer and communication between a wireless power transmitter and a wireless power receiver.

### Description of the Related Art

In wireless power applications, wireless power charging systems may provide the ability to charge and/or power electronic devices without physical, electrical connections, thus reducing the number of components required for operation of the electronic devices and simplifying the use of the electronic device. Such wireless power charging systems may comprise a wireless power transmitter and other transmitting circuitry configured to generate a magnetic field that may be used to wirelessly transfer power to wireless power receivers.

Often, a small amount of data needs to be exchanged between the receiver and transmitter to (for example) control the field strength of the transmitter. This can be done out of band (i.e. using a Bluetooth link) or in-band (i.e. using backscatter communications, also called in-band or load modulation.)

### SUMMARY

Various implementations of methods and devices within the scope of the appended claims each have several aspects, no single one of which is solely responsible for the desirable attributes described herein. Without limiting the scope of the appended claims, some prominent features are described herein.

An aspect of this disclosure is an apparatus for receiving power wirelessly. The apparatus may be characterized by an impedance comprising a resistive component and a reactance component. The apparatus comprises an antenna circuit configured to receive power from a wireless charging field generated by a power transmitter, and to communicate with the power transmitter via a reflected signal, the reflected signal having a fundamental frequency. The apparatus may further comprise a control circuit coupled to the antenna circuit to generate the reflected signal. The reflected signal may be generated by performing at least one of: varying the resistive component of the impedance to generate a signal in the reflected signal having a frequency less than the fundamental frequency, and varying the reactance component of the impedance to change a phase of the reflected signal.

An aspect of this disclosure is an apparatus for receiving power wirelessly. The apparatus may have an impedance comprising a resistive component and a reactance component. The apparatus comprising an antenna circuit configured to receive power from a wireless charging field generated by a power transmitter and to generate a reflected signal based on the power received from the wireless charging field, the reflected signal having a fundamental frequency. The apparatus may further comprise a control circuit coupled to the antenna circuit and configured to transmit a symbol to the power transmitter based on either changing: a power level of the reflected signal at one or more frequencies different from the fundamental frequency of the reflected signal, or a phase of the reflected signal.

An aspect of this disclosure is an apparatus for receiving power wirelessly. The apparatus comprises an antenna circuit configured to receive power from a wireless charging field generated by a power transmitter and to generate a reflected signal based on the power received from the wireless charging field, the reflected signal having a fundamental frequency. The apparatus may further comprise at least one filter circuit configured to filter out at least one harmonic or subharmonic of the fundamental frequency from the reflected signal. The apparatus may further comprise at least one switching circuit operatively coupled to the at least one filter circuit, and configured to either connect or bypass the at least one filter circuit, wherein bypassing the at least one filter circuit allows power of the at least one harmonic or subharmonic to be reflected as part of the reflected signal. The apparatus may further comprise a control circuit configured to transmit a symbol to the power transmitter by operating the at least one switching circuit to control an amount of power at the at least one harmonic or subharmonic of the reflected signal.

An aspect of this disclosure is a method for communicating with a wireless power transmitter. The method comprises receiving power from a wireless charging field generated by the wireless power transmitter at a fundamental frequency via an antenna circuit of a wireless power receiver. The method also comprises adjusting one or more switches of a switching circuit to control an amount of power of at least one harmonic or subharmonic of the fundamental frequency for a signal to be reflected to the wireless power transmitter, the at least one harmonic or subharmonic representative of a symbol. The method further comprises generating the reflected signal to transmit the symbol to the wireless power transmitter.

An aspect of this disclosure is an apparatus for communicating with a wireless power transmitter. The apparatus comprises means for receiving power from a wireless charging field generated by the wireless power transmitter at a fundamental frequency. The apparatus further comprises means for switching configured to control an amount of power of at least one harmonic or subharmonic of the fundamental frequency for a signal to be reflected to the wireless power transmitter, the at least one harmonic or subharmonic representative of a symbol. The apparatus also comprises means for generating the reflected signal to transmit the symbol to the wireless power transmitter.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims.

FIG. 1 is a functional block diagram of a wireless power transfer system, in accordance with one exemplary implementation.

FIG. 2 is a functional block diagram of a wireless power transfer system, in accordance with another exemplary implementation.

FIG. 3 is a schematic diagram of a portion of transmit circuitry or receive circuitry of FIG. 2 including a transmit or receive antenna, in accordance with exemplary implementations.

FIG. 4 is a simplified functional block diagram of a transmitter that may be used in an inductive power transfer system, in accordance with exemplary implementations of the present disclosure.

FIG. 5 is a simplified functional block diagram of a receiver that may be used in the inductive power transfer system, in accordance with exemplary implementations of the present disclosure.

FIG. 6 shows a graph of power levels at various harmonic frequencies in a reflected signal from the receiver to the transmitter.

FIG. 7 illustrates a schematic diagram of another exemplary receiver, in accordance with some embodiments.

FIG. 8 shows a schematic diagram of an exemplary receiver configured to perform harmonic modulation.

FIG. 9 shows a graph of power levels at various harmonic frequencies in a reflected signal modulated by the receiver of FIG. 8, in accordance with some embodiments.

FIG. 10 illustrates another exemplary receiver having an unbalanced rectifier, in accordance with some embodiments

FIG. 11 illustrates a schematic diagram of another exemplary receiver, in accordance with some embodiments.

FIG. 12A shows a graph of voltage amplitude over time of an exemplary unmodulated reflected signal from the receiver to the transmitter.

FIG. 12B shows a graph of voltage amplitude over time of an exemplary modulated reflected signal that from the receiver to the transmitter.

FIG. 13 illustrates a schematic diagram of another exemplary receiver 1300 for implementing modulation for multiple harmonics.

FIG. 14 shows a graph of power levels at various harmonic frequencies in a reflected signal modulated by the receiver of FIG. 13.

FIG. 15 shows another graph of power levels at various harmonic frequencies in a reflected signal modulated by the receiver of FIG. 13.

FIG. 16 illustrates a schematic diagram of another exemplary receiver configured to implement load modulation.

FIG. 17 shows graph of power levels at various frequencies in a modulated reflected signal modulated by the receiver of FIG. 16.

FIG. 18 shows a graph of amplitude over time of an exemplary modulated reflected signal modulated by the receiver of FIG. 16.

FIG. 19 illustrates a schematic diagram of another exemplary receiver configured to be able to change a phase of the reflected signal.

FIG. 20 illustrates a receiver using of a variable capacitor to tune the receiver, in accordance with some embodiments.

FIG. 21 illustrates a schematic diagram of another exemplary receiver comprising a synchronous rectifier.

FIG. 22 shows graphs of voltage values at the inputs of the rectifier of FIG. 21 over time, and current values at the receive coil over time, in accordance with some embodiments.

FIG. 23 illustrates examples of different drive signals that may be used to drive the synchronous rectifier relative to an incoming signal from the transmitter to the receiver.

FIG. 24 illustrates a schematic diagram of another exemplary receiver configured to implement combined signaling.

FIG. 25 shows a table showing possible symbol combinations that may be achieved by the receiver of FIG. 24 using combined signaling.

FIG. 26 shows a schematic diagram of a frequency modulation circuit of an exemplary receiver of FIG. 16 configured to perform frequency modulation.

FIG. 27 shows a schematic diagram of a frequency modulation circuit as integrated into an exemplary receiver of FIG. 16 configured to perform frequency modulation.

FIG. 28 shows a schematic diagram of an exemplary mixer circuit configured to perform frequency modulation.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary implementations and is not intended to represent the only implementations in which the present disclosure may be practiced. The term “exemplary” used throughout this description means “serving as an example, instance, or illustration,” and should not necessarily be construed as preferred or advantageous over other exemplary implementations. The detailed description includes specified details for the purpose of providing a thorough understanding of the exemplary implementations. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

FIG. 1 is a functional block diagram of a wireless power transfer system 100, in accordance with one exemplary implementation. Input power 102 may be provided to a transmitter 104 from a power source (not shown) to generate a wireless (e.g., magnetic or electromagnetic) field 105 for performing wireless power transfer. A receiver 108 may couple to the wireless field 105 and generate output power 110 for storage or consumption by a device (not shown) coupled to the output power 110. Both the transmitter 104 and the receiver 108 are separated by a distance 112.

In one exemplary implementation, the transmitter 104 and the receiver 108 are configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over a larger distance in contrast to purely inductive solutions that may require large antenna coils which are very close (e.g., sometimes within millimeters). Resonant inductive coupling techniques may thus allow for improved efficiency and power transfer over various distances and with a variety of inductive coil configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104 as will be further described below. The wireless field 105 may also operate over a longer distance than is considered “near field.” The transmitter 104 may include a transmit antenna 114 (e.g., a coil) for transmitting energy to the receiver 108. The receiver 108 may include a receive antenna or coil 118 for receiving or capturing energy transmitted from the transmitter 104. The near-field may correspond to a region in which there are strong reactance fields resulting from the currents and charges in the transmit antenna 114 that minimally radiate power away from the transmit antenna 114. The near-field may correspond to a region that is within about one wavelength (or a fraction thereof) of the transmit antenna 114.

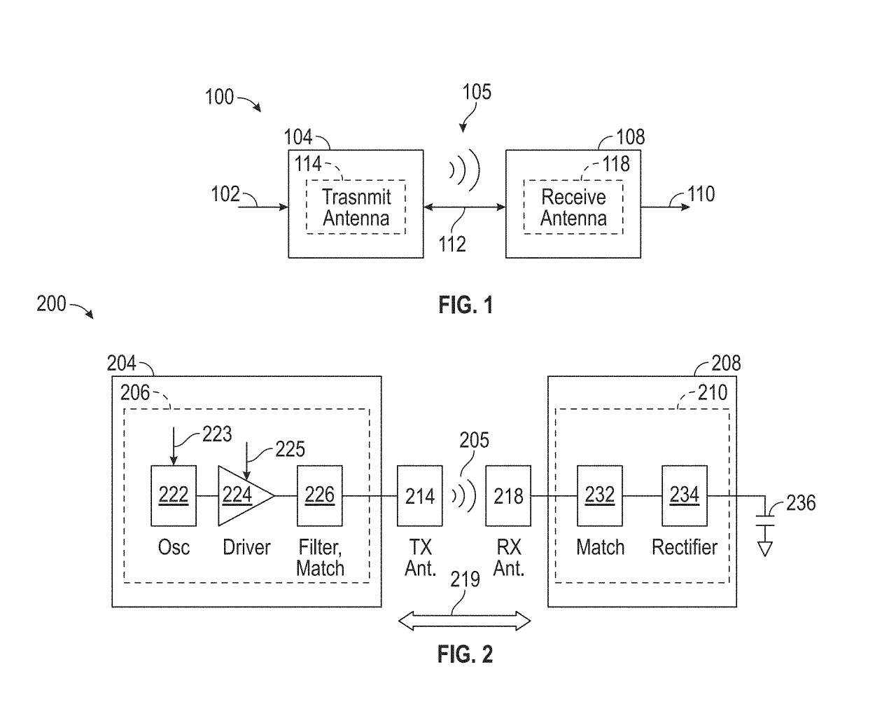

FIG. 2 is a functional block diagram of a wireless power transfer system 200, in accordance with another exemplary implementation. The system 200 includes a transmitter 204 and a receiver 208. The transmitter 204 may include a transmit circuitry 206 that may include an oscillator 222, a driver circuit 224, and a filter and matching circuit 226. The oscillator 222 may be configured to generate a signal at a desired frequency that may be adjusted in response to a frequency control signal 223. The oscillator 222 may provide the oscillator signal to the driver circuit 224. The driver circuit 224 may be configured to drive the transmit antenna 214 at, for example, a resonant frequency of the transmit antenna 214 based on an input voltage signal (VD) 225. The driver circuit 224 may be a switching amplifier configured to receive a square wave from the oscillator 222 and output a sine wave. For example, the driver circuit 224 may be a class E amplifier.

The filter and matching circuit 226 may filter out harmonics or other unwanted frequencies (e.g., subharmonics) and match the impedance of the transmitter 204 to the impedance of the transmit antenna 214. As a result of driving the transmit antenna 214, the transmit antenna 214 may generate a wireless field 205 to wirelessly output power at a level sufficient for charging a battery 236.

The receiver 208 may include a receive circuitry 210 that may include a matching circuit 232 and a rectifier circuit 234. The matching circuit 232 may match the impedance of the receive circuitry 210 to the receive antenna 218. The rectifier circuit 234 may generate a direct current (DC) power output from an alternate current (AC) power input to charge the battery 236, as shown in FIG. 2. The receiver 208 and the transmitter 204 may additionally communicate on a separate communication channel 219 (e.g., Bluetooth, ZigBee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236.

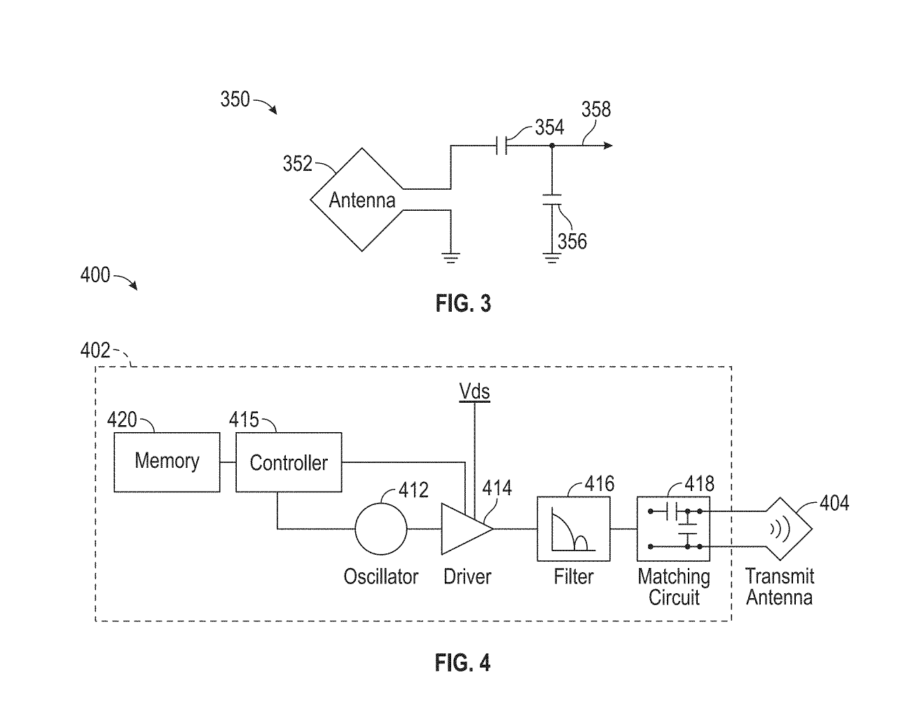

FIG. 3 is a schematic diagram of a portion of the transmit circuitry 206 or the receive circuitry 210 of FIG. 2 including a transmit or receive antenna, in accordance with exemplary implementations. As illustrated in FIG. 3, a transmit or receive circuitry 350 may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna may also be referred to as a coil of a type that is configured to wirelessly output or receive power. As used herein, the antenna 352 is an example of a “power transfer component” of a type that is configured to wirelessly output and/or receive power.

The antenna 352 may include an air core or a physical core such as a ferrite core (not shown).

The transmit or receive circuitry 350 may form/include a resonant circuit. The resonant frequency of the loop or magnetic antennas is based on the inductance and capacitance. Inductance may be simply the inductance created by the antenna 352, whereas, capacitance may be added to the antenna's inductance to create a resonant structure at a desired resonant frequency. As a non-limiting example, a capacitor 354 and a capacitor 356 may be added to the transmit or receive circuitry 350 to create a resonant circuit. For a transmit circuitry, a signal 358 may be an input at a resonant frequency to cause the antenna 352 to generate a wireless field 105/205. For receive circuitry, the signal 358 may be an output to power or charge a load (not shown). For example, the load may comprise a wireless device configured to be charged by power received from the wireless field.

Referring to FIGS. 1 and 2, the transmitter 104/204 may output a time varying magnetic (or electromagnetic) field with a frequency corresponding to the resonant frequency of the transmit antenna 114/214. When the receiver 108/208 is within the wireless field 105/205, the time varying magnetic (or electromagnetic) field may induce a current in the receive antenna 118/218. As described above, if the receive antenna 118/218 is configured to resonate at the frequency of the transmit antenna 114/214, energy may be efficiently transferred. The AC signal induced in the receive antenna 118/218 may be rectified as described above to produce a DC signal that may be provided to charge or to power a load.

FIG. 4 is a simplified functional block diagram of a transmitter that may be used in an inductive power transfer system, in accordance with exemplary implementations of the present disclosure. As shown in FIG. 4, the transmitter 400 includes transmit circuitry 402 and a transmit antenna 404 operably coupled to the transmit circuitry 402. The transmit antenna 404 may be configured as the transmit antenna 214 as described above in reference to FIG. 2. In some implementations, the transmit antenna 404 may be a coil (e.g., an induction coil). In some implementations, the transmit antenna 404 may be associated with a larger structure, such as a table, mat, lamp, or other stationary configuration. The transmit antenna 404 may be configured to generate an electromagnetic or magnetic field. In an exemplary implementation, the transmit antenna 404 may be configured to transmit power to a receiver device within a charging region at a power level sufficient to charge or power the receiver device.

The transmit circuitry 402 may receive power through a number of power sources (not shown). The transmit circuitry 402 may include various components configured to drive the transmit antenna 404. In some exemplary implementations, the transmit circuitry 402 may be configured to adjust the transmission of wireless power based on the presence and constitution of the receiver devices as described herein. As such, the transmitter 400 may provide wireless power efficiently and safely.

The transmit circuitry 402 may further include a controller 415. In some implementations, the controller 415 may be a micro-controller. In other implementations, the controller 415 may be implemented as an application-specified integrated circuit (ASIC). The controller 415 may be operably connected, directly or indirectly, to each component of the transmit circuitry 402. The controller 415 may be further configured to receive information from each of the components of the transmit circuitry 402 and perform calculations based on the received information. The controller 415 may be configured to generate control signals for each of the components that may adjust the operation of that component. As such, the controller 415 may be configured to adjust the power transfer based on a result of the calculations performed by it.

The transmit circuitry 402 may further include a memory 420 operably connected to the controller 415. The memory 420 may comprise random-access memory (RAM), electrically erasable programmable read only memory (EEPROM), flash memory, or non-volatile RAM. The memory 420 may be configured to temporarily or permanently store data for use in read and write operations performed by the controller 415. For example, the memory 420 may be configured to store data generated as a result of the calculations of the controller 415. As such, the memory 420 allows the controller 415 to adjust the transmit circuitry 402 based on changes in the data over time.

The transmit circuitry 402 may further include an oscillator 412 operably connected to the controller 415. The oscillator 412 may be configured as the oscillator 222 as described above in reference to FIG. 2. The oscillator 412 may be configured to generate an oscillating signal (e.g., radio frequency (RF) signal) at the operating frequency of the wireless power transfer. In some exemplary implementations, the oscillator 412 may be configured to operate at the 6.78 MHz ISM frequency band. The controller 415 may be configured to selectively enable the oscillator 412 during a transmit phase (or duty cycle). The controller 415 may be further configured to adjust the frequency or a phase of the oscillator 412 which may reduce out-of-band emissions, especially when transitioning from one frequency to another. As described above, the transmit circuitry 402 may be configured to provide an amount of power to the transmit antenna 404, which may generate energy (e.g., magnetic flux) about the transmit antenna 404.

The transmit circuitry 402 may further include a driver circuit 414 operably connected to the controller 415 and the oscillator 412. The driver circuit 414 may be configured as the driver circuit 224 as described above in reference to FIG. 2. The driver circuit 414 may be configured to drive the signals received from the oscillator 412, as described above.

The transmit circuitry 402 may further include a low pass filter (LPF) 416 operably connected to the transmit antenna 404. The low pass filter 416 may be configured as the filter portion of the filter and matching circuit 226 as described above in reference to FIG. 2. In some exemplary implementations, the low pass filter 416 may be configured to receive and filter an analog signal of current and an analog signal of voltage generated by the driver circuit 414. The analog signal of current may comprise a time-varying current signal, while the analog signal of current may comprise a time-varying voltage signal. In some implementations, the low pass filter 416 may alter a phase of the analog signals. The low pass filter 416 may cause the same amount of phase change for both the current and the voltage, canceling out the changes. In some implementations, the controller 415 may be configured to compensate for the phase change caused by the low pass filter 416. The low pass filter 416 may be configured to reduce harmonic or subharmonic emissions to levels that may prevent self-jamming. Other exemplary implementations may include different filter topologies, such as notch filters that attenuate specified frequencies while passing others.

The transmit circuitry 402 may further include a fixed impedance matching circuit 418 operably connected to the low pass filter 416 and the transmit antenna 404. The matching circuit 418 may be configured as the matching portion of the filter and matching circuit 226 as described above in reference to FIG. 2. The matching circuit 418 may be configured to match the impedance of the transmit circuitry 402 (e.g., 50 ohms) to the transmit antenna 404. Other exemplary implementations may include an adaptive impedance match that may be varied based on measurable transmit metrics, such as the measured output power to the transmit antenna 404 or a DC current of the driver circuit 414. The transmit circuitry 402 may further comprise discrete devices, discrete circuits, and/or an integrated assembly of components.

Transmit antenna 404 may be implemented as an antenna strip with the thickness, width and metal type selected to keep resistance losses low.

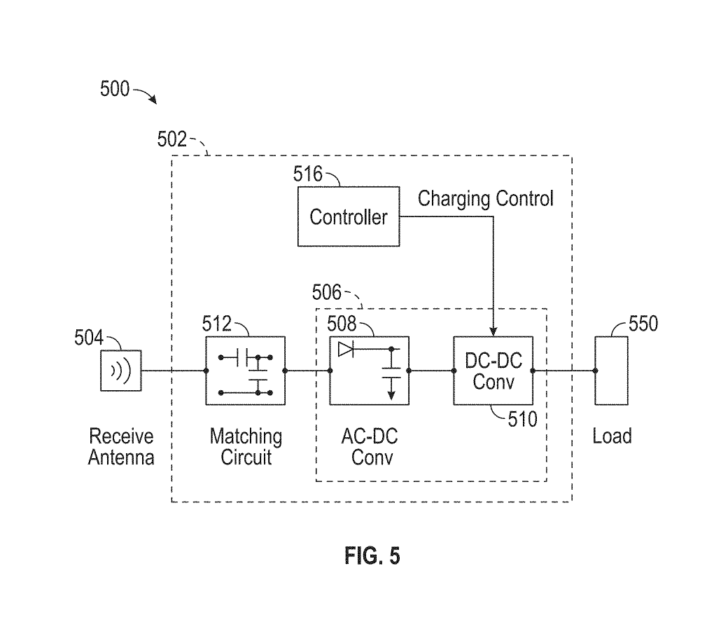

FIG. 5 is a block diagram of a receiver, in accordance with an implementation of the present disclosure. As shown in FIG. 5, a receiver 500 includes a receive circuitry 502, a receive antenna 504, and a load 550. The receiver 500 further couples to the load 550 for providing received power thereto. Receiver 500 is illustrated as being external to device acting as the load 550 but may be integrated into load 550. The receive antenna 504 may be operably connected to the receive circuitry 502. The receive antenna 504 may be configured as the receive antenna 218 as described above in reference to FIG. 2. In some implementations, the receive antenna 504 may be tuned to resonate at a frequency similar to a resonant frequency of the transmit antenna 404, or within a specified range of frequencies, as described above. The receive antenna 504 may be similarly dimensioned with transmit antenna 404 or may be differently sized based upon the dimensions of the load 550. The receive antenna 504 may be configured to couple to the magnetic field generated by the transmit antenna 404, as described above, and provide an amount of received energy to the receive circuitry 502 to power or charge the load 550.

The receive circuitry 502 may be operably coupled to the receive antenna 504 and the load 550. The receive circuitry may be configured as the receive circuitry 210 as described above in reference to FIG. 2. The receive circuitry 502 may be configured to match an impedance of the receive antenna 504, which may provide efficient reception of wireless power. The receive circuitry 502 may be configured to generate power based on the energy received from the receive antenna 504. The receive circuitry 502 may be configured to provide the generated power to the load 550. In some implementations, the receiver 500 may be configured to transmit a signal to the transmitter 400 indicating an amount of power received from the transmitter 400.

The receive circuitry 502 may include a processor-signaling controller 516 configured to coordinate the processes of the receiver 500 described below.

The receive circuitry 502 provides an impedance match to the receive antenna 504. The receive circuitry 502 includes power conversion circuitry 506 for converting a received energy into charging power for use by the load 550. The power conversion circuitry 506 includes an AC-to-DC converter 508 coupled to a DC-to-DC converter 510. The AC-to-DC converter 508 rectifies the AC energy signal received at the receive antenna 504 into a non-alternating power while the DC-to-DC converter 510 converts the rectified AC energy signal into an energy potential (e.g., voltage) that is compatible with the load 550. Various AC-to-DC converters are contemplated including partial and full rectifiers, regulators, bridges, doublers, as well as linear and switching converters.

The receive circuitry 502 may further include a matching circuit 512. The matching circuit 512 may comprise one or more resonant capacitors in either a shunt or a series configuration. In some implementations these resonant capacitors may tune the receive antenna to a specific frequency or to a specific frequency range (e.g., a resonant frequency).

The load 550 may be operably connected to the receive circuitry 502. The load 550 may be configured as the battery 236 as described above in reference to FIG. 2. In some implementations the load 550 may be external to the receive circuitry 502. In other implementations the load 550 may be integrated into the receive circuitry 502.

### Signaling Between Transmitter and Receiver

As discussed above, often a small amount of data needs to be exchanged between the receiver 208 and transmitter 204 to (for example) control the field strength of the transmitter 204. This can be done out of band (e.g., using the separate communication channel 219, such as a Bluetooth link) or in-band (e.g., using backscatter communications, also called in-band or load modulation.)

In some embodiments wherein the system 200 uses out of band signaling, the system may experience cross-connection, where an out of band link causes the receiver 208 to connect to a different power transmitter (not shown) while the receiver 208 is receiving power from the power transmitter 204. In addition, implementing out of band signaling typically requires an additional link (e.g., separate communication channel 219) requiring the transmitter 204 and the receiver 208 to implement another radio with the associated costs.

In some embodiments, the system 200 may use in-band signaling. The receiver 208, in response to the wireless field 205 being transmitted from the transmitter 204 to the receiver 208, may transmit a reflected signal back to the transmitter 204 (e.g., using backscatter communications). The receiver 208 may modify the reflected signal (discussed in greater detail below) to encode signal data as part of the reflected signal. In some embodiments where the system 200 uses in-band signaling, it may be desirable for the signal to be able to break out of the fundamental power signal of the wireless field 205. For example, coupling from a large transmitter 204 to a small receiver 208 (as is often the case with medical implants) may result in a very low mutual inductance between transmitter and receiver coils 214 and 218. As such, in-band signaling by the receiver 208 at the fundamental of the wireless field 205 may result in a low signal in the presence of a very strong one—resulting in a low SNR (signal-to-noise ratio). In addition, when the mutual inductance between transmitter and receiver coils 214 and 218 is low, there may be a first loss in signal from the transmitter 204 to the receiver 208, then a second loss in reflected signal from the receiver 208 to the transmitter 204. This may result in a low reflected signal back to the transmitter 204, even when the fundamental (e.g., which may be considered “noise” for the purpose of signaling) is strong. As the power at the fundamental may be much stronger than the signal, the signal may be difficult for the transmitter 204 to detect.

In some embodiments, it may be desirable to implement in-band signaling using harmonic modulation in order to improve the SNR of the signal. Harmonic modulation may be used to generate a signal at a harmonic frequency of the fundamental as part of the reflected signal, instead of at the fundamental. In some embodiments, the signal at the harmonic frequency may be generated by adding nonlinearity at the receiver 208 or by removing filtering around an existing nonlinearity, thereby increasing the energy in one or more harmonics associated with the nonlinearity. Note that for the purposes of this document, the term “in-band signaling” may be used for signals that are harmonically related to the fundamental signal (e.g., a multiple of the fundamental), but are at different frequencies from the fundamental signal.

In some embodiments, subharmonic signaling may be used to improve the SNR of in-band communications. Subharmonic signaling may use impedance modulation to generate a signal below the fundamental power frequency. For example, if the transmitter 204 uses a 6.78 MHz power transmission frequency, and a subharmonic signal uses a divide-by-two ratio, then a signal would appear at 3.39 MHz. In some embodiments, this sub-harmonic signal may be easy to decode because, unlike regular harmonics (which are always above the frequency of the fundamental), there should be little to no interference at the frequency of the signal caused by receiver nonlinearities.

In some embodiments, the receiver 208 may communicate with the transmitter 204 using in-band communications by generating a reflected electromagnetic signal (e.g., backscatter modulating) due to nonlinearities in the receiver 208 that may be detected by the transmitter 204. In some embodiments, the backscatter signal may be generated at the receiver 208 by changing an amount of detected impedance or harmonic content at the transmitter 204 (e.g., impedance modulating).

### In-Band Signaling Using Harmonic Modulation

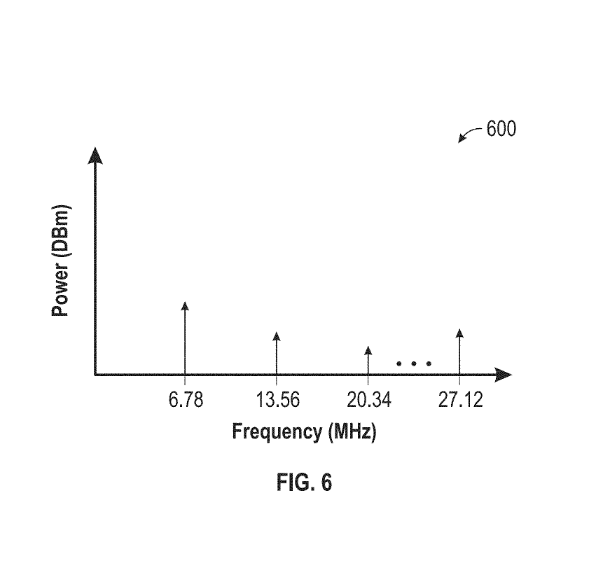

FIG. 6 shows a graph 600 of power levels at various harmonic frequencies in a reflected signal from the receiver 208 to the transmitter 204. The transmitter 204 and receiver 208 may have a 6.78 MHz transmit frequency, resulting in the reflected signal having a fundamental frequency of 6.78 MHz. Graph 600 has an x-axis corresponding to frequency in MHz and a y-axis corresponding to power level (e.g., measured in DBm or decibel-milliwatts). As illustrated in the graph 600, the reflected signal may comprise an amount of power at the fundamental frequency of 6.78 MHz as well as multiples of the fundamental frequency (e.g., at 13.56 MHz, 20.34 MHz, and 27.12 MHz), hereinafter referred to as harmonics. The graph 600 shows arrows indicating the power level at the fundamental frequency and each of the harmonics.

In some embodiments, nonlinearities in the transmitter 204 and/or receiver 208 may cause harmonics in the reflected signal at multiples of the fundamental frequency (at 2×, 3×, 4×, etc.). The power at the harmonics (e.g., 13.56 MHz, 20.34 MHz, etc.) may vary based upon the specific nonlinearities of the transmitter and/or receiver 208 (e.g., the power at the 20.34 MHz harmonic may be lower than that at the 13.56 MHz or 27.12 MHz harmonics). However, as illustrated in FIG. 6, the power at the harmonics in the reflected signal may be substantially lower than the power at the fundamental frequency (6.78 MHz). In addition, there is typically no power in the reflected signal below the fundamental frequency of 6.78 MHz. It is understood that while the present specification may refer primarily to a fundamental frequency of 6.78 MHz, in other embodiments, any fundamental frequency may be used.

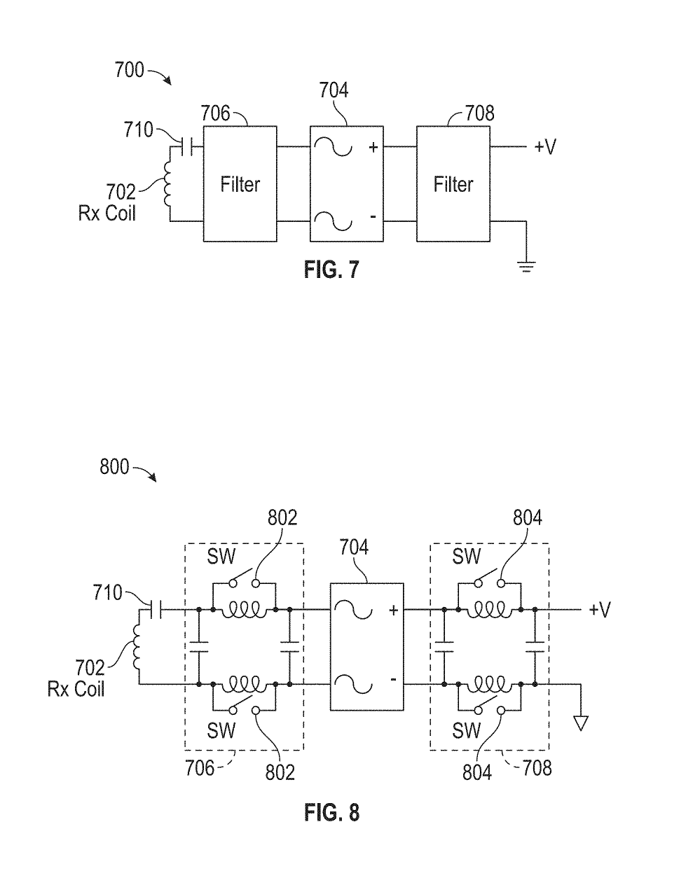

FIG. 7 illustrates a schematic diagram of another exemplary receiver 700, in accordance with some embodiments. The receiver 700 may correspond to the receiver 108 as illustrated in FIG. 1, the receiver 208 as illustrated in FIG. 2, or the receiver 500 as illustrated in FIG. 5. The receiver 700 comprises a receiver antenna 702 (also referred to as a receiver coil or RX coil, which may correspond to the receive antenna 118, a receiver antenna 218, or the receive antenna 504), a rectifier 704 (which may correspond to the power conversion circuitry 506 illustrated in FIG. 5), and one or more filters (e.g., a first filter 706 and a second filter 708). As illustrated in FIG. 7, the rectifier 704 may be located between the filters 706 and 708.

In some embodiments, each of the first and second filters 706 and 708 may comprise a band-stop filter or a low pass filter configured to filter certain frequencies from a signal reflected from the receiver 700 to a transmitter (e.g., transmitter 104, 204, or 400). For example, in some embodiments, the filters 706 and 708 may be configured to attenuate certain harmonics of the reflected signal. In some embodiments, the receiver 700 may further comprise a tuning capacitor 710 or other reactance element to balance the impedance of the receiver coil 702, such that the receiver 700 will be at resonance (e.g., have an impedance with no imaginary part). For example, the tuning capacitor 710 may be located in series with the receiver antenna 702.

While FIG. 7 illustrates the components of the receiver 700 in certain locations (e.g., the rectifier 704 being between the filters 706 and 708), it is understood that in other embodiments, the various components may be placed in different arrangements.

FIG. 8 shows a schematic diagram of an exemplary receiver 800 configured to perform harmonic modulation. The receiver 800 may comprise a receiver antenna 702, rectifier 704, filters 706 and 708, and tuning capacitor 710, similar to those of the rectifier 700 illustrated in FIG. 7. As illustrated in FIG. 8, the filters 706 and 708 may correspond to low-pass filters, each comprising a parallel pair of capacitors and a parallel pair of inductors.

In some embodiments, the receiver 800 may comprise switches 802 and 804 across the one or more filters 706 and 708 (e.g., low-pass filters). For example, the switches 802 and 804 may be arranged to be in parallel with each of the inductors of the filters 706 and 708. As discussed above, the filters 706 and 708 may be configured to block the harmonics generated by the nonlinear components of the receiver 800 (e.g., diodes in the rectifier 704) from being reflected to the transmitter 400 as part of the reflected signal. The switches 802 and 804 may be configured to connect or bypass an associated filter 706 or 708. For example, when the switches 802 are open, the filter 706 may be connected and be able to attenuate an associated harmonic. On the other hand, if the switches 802 are closed, the filter 706 will be bypassed or shorted out, causing an increase in power of the associated harmonic in the reflected signal. In some embodiments, only one switch 802 needs to be closed at a time (thus bypassing at least a portion of a corresponding filter 706) to cause an increase in harmonic power.

As illustrated in FIG. 8, each filter 706 and 708 may be associated with more than one switch 802 or 804. Closing one switch 802 or 804 to bypass half the filter 706 or 708 may result in less signal power at the corresponding harmonic than bypassing the entire filter 706 or 708 (e.g., by closing both switches 802 or 804 corresponding to the filter 706 or 708). On the other hand, closing additional switches 802 or 804 (e.g., closing all four switches 802 and 804) would cause a strong change in reflected harmonic power. In some embodiments, the filters 706 or 708 may be associated with only one switch 802 or 804 for bypassing at least a portion of the filter 706 or 708.

In some embodiments, the first filter 706 and/or the second filter 708 may be shorted out under program control (e.g., by the controller 516) in order to modulate the reflected signal to produce an in-band signal that may be detected by the transmitter 400. For example, when shorted out using switches 802 and/or 804, the filters 706 and/or 708 will stop blocking the harmonics they are designed to attenuate. As a result, more power may be passed to those harmonics of the reflected signal. Since the power at the harmonics of the reflected signal is typically much lower than the power at the fundamental frequency, changes in power at the harmonics of the reflected signal may be easy for the transmitter 400 to detect in comparison to changes in power at the fundamental.

In some embodiments, the transmitter 400 may detect the in-band signal as a difference between the original and increased harmonic power of the reflected signal. In some embodiments, the transmitter 400 may detected the in-band signal as a change in the phase of the harmonic power of the reflected signal. For example, in some embodiments, instead of switches 802 or 804 shorting a filter 706 or 708, the controller 516 may adjust the tuning of the filter 706 or 708 to change the phase of an associated harmonic with respect to the phase of the incoming power (e.g., via the wireless field 205). In some embodiments, adjustment of a phase of a filter 706 or 708 may be done using a transcap or other type of variable capacitor (not shown).

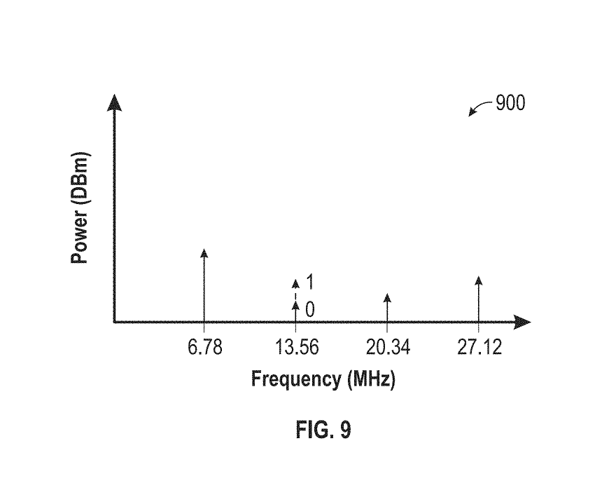

FIG. 9 shows a graph 900 of power levels at various harmonic frequencies in a reflected signal modulated by the receiver 800 of FIG. 8, in accordance with some embodiments. Graph 900 shows an x-axis corresponding to frequency in MHz and a y-axis corresponding to power level. Similar to the reflected signal illustrated in FIG. 6, the modulated reflected signal may have a highest amount of power at the fundamental frequency of 6.78 MHz, as well as lower amounts of power at each of the harmonic frequencies of 13.56 MHz, 20.34 MHz, and 27.12 MHz. The two arrows shown at the 13.56 MHz harmonic (solid and dotted arrows) indicate two different levels of modulation at the 13.56 MHz harmonic that may be used to transmit a symbol to the transmitter 400 using the reflected signal (e.g., a “0” or a “1” value).

The controller 516 may increase or decrease an amount of power passed to a harmonic (e.g., the 13.56 MHz harmonic) of the reflected signal by shorting or connecting a corresponding filter 706 or 708 (e.g., using one or more switches 802 or 804), to indicate a 1 or 0 value. For example, when the corresponding filter 706 or 708 is shorted, the power at the 13.56 MHz harmonic may increase (indicated by the dotted line at the 13.56 MHz frequency in the graph 900), signaling a value of 1. On the other hand, when the associated filter 706 or 708 is not shorted, the power at the 13.56 MHz harmonic may be lowered due to attenuation by the filter 706 or 708 (indicated by the solid line at the 13.56 MHz frequency in the graph 900), signaling a value of 0.

While the illustrated figures shows modulation of a 2^{nd} harmonic (e.g., 13.56 MHz), it is understood that in other embodiments, the controller 516 may modulate any harmonic. For example, in some embodiments the rectifier 704 may only produce odd harmonics. In other embodiments, the rectifier 704 may generate even harmonics as a result of one or more parasitics. For example, a diode (not shown) in a full bridge of the rectifier 704 could have a series resistance that would create a controlled level of even harmonics. In some embodiments, the rectifier 704 may comprise a synchronous rectifier, wherein timing of the synchronous rectifier could also be done to generate even harmonics.

In some embodiments, the controller 516 may generate an even harmonic (e.g., a second harmonic) by “unbalancing” the rectifier 704.

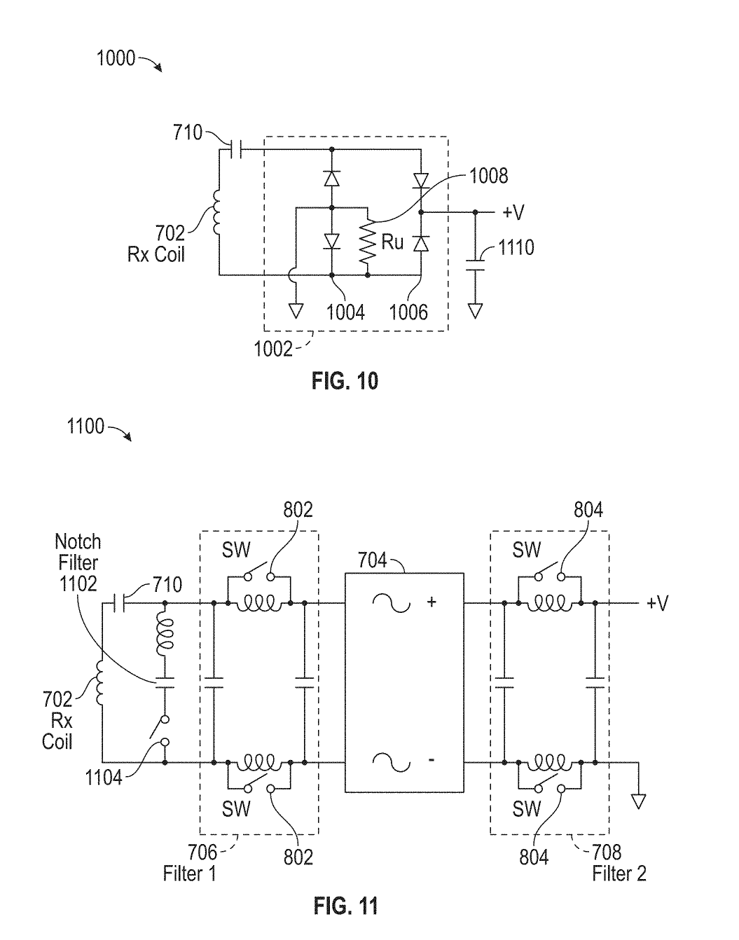

FIG. 10 illustrates another exemplary receiver 1000 having an unbalanced rectifier 1002, in accordance with some embodiments. The receiver 1000 may comprise a receiver antenna 702 and tuning capacitor 710 similar to those of the receiver 700 of FIG. 7. The receiver 1000 may further comprise one or more low-pass or band-pass filters (not shown) similar to filters 706 and/or 708. In some embodiments, a filtering capacitor 1110 may be connected to an output of the rectifier 1002 to filter a DC output of the rectifier 1002.

In some embodiments, the rectifier 1002 of the receiver 1000 may be similar to the rectifier 704 of FIG. 7, and may comprise a first branch 1004 and a second branch 1006. An unbalancing resistor 1008 is coupled to the first branch 1004 to generate a second harmonic, in accordance with some embodiments. In some embodiments, the unbalancing resistor Ru 1008 may be a fixed element within the rectifier 1002. In other embodiments, the controller 516 may switch the unbalancing resistor Ru 1008 in and out of the rectifier 1002 as needed to cause generation of the second harmonic. For example, in some embodiments, the unbalancing resistor Ru 1008 may be connected to the rectifier 1002 to produce power at the second harmonic (e.g., to signal a “1”), and disconnected from the rectifier 1002 to reduce or eliminate the second harmonic (e.g., to signal a “0”).

FIG. 11 illustrates a schematic diagram of another exemplary receiver 1100, in accordance with some embodiments. The receiver 1100 may comprise a receiver coil 702, rectifier 704, filters 706/708, and tuning capacitor 710 similar to those of the receiver 700 illustrated in FIG. 7. In addition, the filters 706 and/or 708 may be connected or shorted using switches 802 and/or 804, similar to those of the receiver 800 of FIG. 8.

In addition, as shown in the figure, the receiver 1100 may comprise a notch filter 1102 configured to filter certain frequency ranges (e.g., a frequency range corresponding to a particular harmonic). In some embodiments, the notch filter 1102 may be configured to be parallel to the receiver coil 702 and the tuning capacitor 710, although it is understood that other configurations may also be possible. The controller 516 may be configured to switch the notch filter 1102 in or out of the receiver 1100 (e.g., using a switch 1104) in order to reduce or increase the power of the particular corresponding harmonic. In addition, in some embodiments, a capacitor of the notch filter 1102 may be tunable to adjust the phase and/or magnitude of the targeted harmonic.

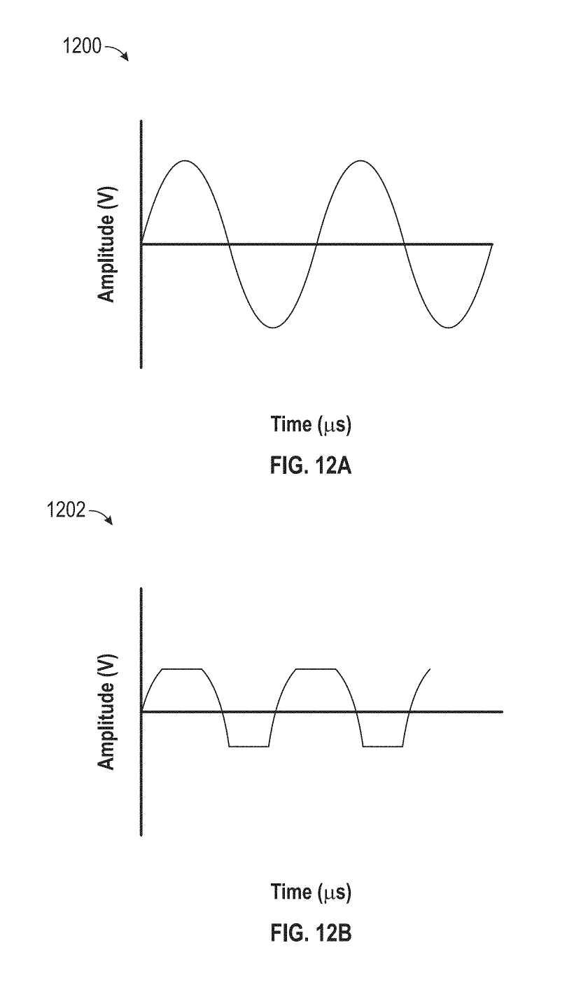

FIG. 12A shows a graph of voltage amplitude over time of an exemplary unmodulated reflected signal from any of the receivers 500, 700, 800, 1000 or 1100 to the transmitter 400. Graph 1200 shows an x-axis corresponding to time in μs and a y-axis corresponding to power level. As shown in FIG. 12A, the unmodified reflected signal may be substantially sinusoidal.

FIG. 12B shows a graph 1202 of voltage amplitude over time of an exemplary modulated reflected signal that from any of the receivers 800, 1000, or 1100 to the transmitter 400. Like the graph 1200, the graph 1202 shows an x-axis corresponding to time in μs and a y-axis corresponding to power level. Modulating the reflected signal (e.g., by closing one or more switches 802 or 1104, and thus bypassing one or more filters 706, 708, or 1102) may result in a change in the reflected signal. For example, as illustrated in FIG. 12B, the amplitude of the modulated signal appears more like a square wave than a sine wave and comprises more harmonic content in comparison with the unmodulated signal illustrated in FIG. 12A.

### Harmonic Modulation Using Multiple Harmonics

In some cases, the receiver 208 may modulate more than one harmonic for in-band signaling purposes, in order to improve signal to noise ratio or to improve signaling throughput. For example, in some embodiments, filters 706, 708, and/or 1102 (as illustrated in FIG. 11) may each be associated different harmonics. By bypassing or connecting the filters 706, 708, and 1102, power at different combinations of harmonics may be increased or decreased.

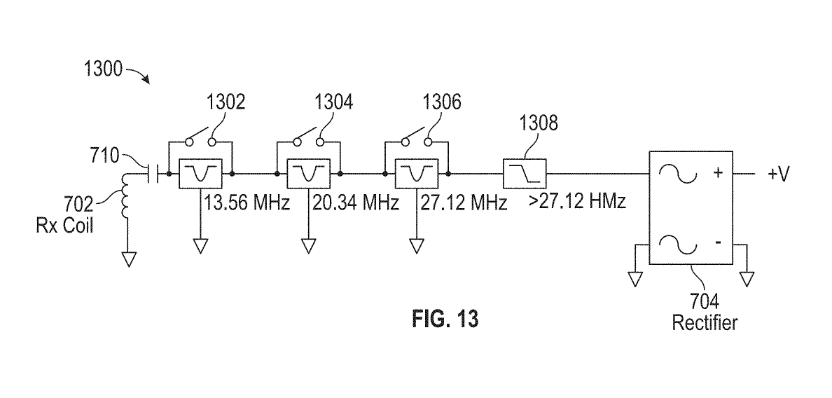

FIG. 13 illustrates a schematic diagram of another exemplary receiver 1300 for implementing modulation for multiple harmonics. In some embodiments, in order to implement a modulation scheme involving multiple harmonics, the receiver 1300 may comprise multiple bandpass or lowpass filters. The receiver 1300 may comprise a receiver coil 702, rectifier 704 and tuning capacitor similar to the receiver 700 illustrated in FIG. 7. In addition, as illustrated in FIG. 13, three switchable bandpass filters 1302, 1304, and 1306 allow for modulation of three different harmonics (e.g., harmonics corresponding to 13.56 MHz, 20.34 MHz, and 27.12 MHz, respectively). In some embodiments, the receiver 1300 may include a bandpass filter 1308 configured to filter frequencies above the top harmonic being modulated (e.g., 27.12 MHz), in order to reduce emissions of higher frequencies for EMI purposes. As illustrated in FIG. 13, the plurality of filters 1302, 1304, 1306, and 1308 may be positioned between the tuning capacitor 710 and the rectifier 704, although it is understood that other configurations are also possible.

By connecting or disconnecting the filters 1302, 1304, and/or 1306, the power at respective harmonics may be decreased or increased. For example, opening a switch associated with the filter 1302 may cause the filter 1302 to filter power at the 13.56 MHz harmonic, decreasing the power at the harmonic. On the other hand, closing the switch to bypass the filter 1302 will cause the power level at the 13.56 MHz harmonic to increase. In some embodiments, the filters 1302, 1304, and 1306 may be similar to the filters 706, 708, and/or 1102. In addition, although FIG. 13 illustrates switches that may be used to short each of the filters 1302, 1304, and 1306, it is understood that in some embodiments, one or more switches may be used to disconnect a filter 1302, 1304, or 1306 from the receiver 1300 instead of shorting the respective filter.

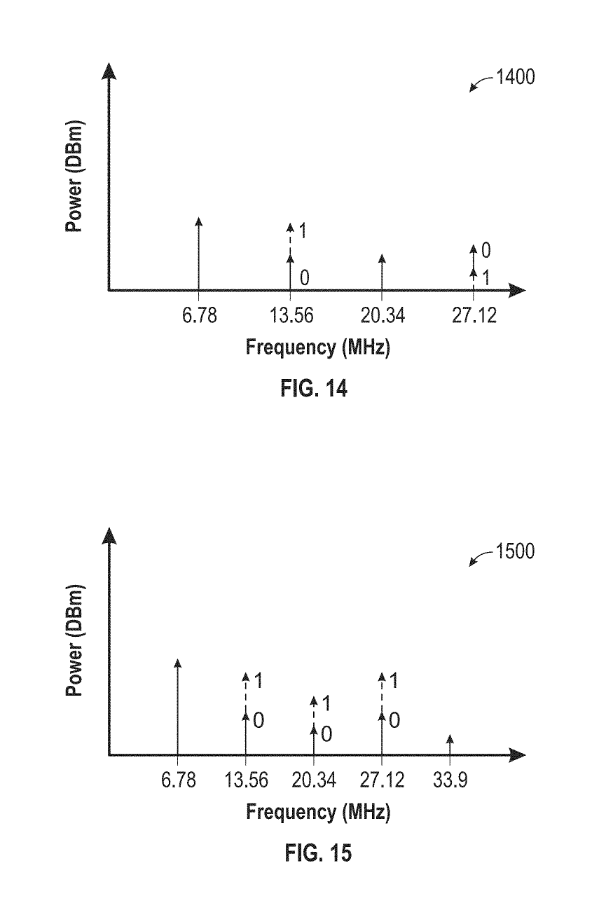

FIG. 14 shows a graph 1400 of power levels at various harmonic frequencies in a reflected signal modulated by the receiver 1300 of FIG. 13. The graph 1400 shows an x-axis corresponding to frequency in MHz and a y-axis corresponding to power level. Similar to the reflected signal illustrated in FIG. 6, the modulated reflected signal may have a highest amount of power at the fundamental frequency of 6.78 MHz, as well as lower amounts of power at each of the harmonic frequencies of 13.56 MHz, 20.34 MHz, and 27.12 MHz. The two arrows at the 13.56 MHz harmonic and the 27.12 MHz harmonic illustrate different levels of power that may be at the harmonics, based upon the modulation performed by the receiver 1300.

As illustrated in the graph 1400, more than one harmonic of the reflected signal may be modulated. In this example, the harmonics of the reflected signal at 13.56 MHz and 27.12 MHz may be modulated oppositely in a complementary fashion (e.g., one is increased while the other is decreased) in order to improve noise rejection. For example, in order to signal a “1”, the receiver 1300 may cause the power at the 13.56 MHz harmonic to be increased (e.g., by shorting the filter 1302 associated with the 13.56 MHz harmonic), while causing power at the 27.12 MHz harmonic to be decreased (e.g., by connecting the filter 1306 associated with the 27.12 MHz harmonic). This is shown in the graph 1400 by the higher power level at the 13.56 MHz harmonic and the lower power level at the 27.12 MHz harmonic. Similarly, the receiver 1300 may signal a “0” may causing the power at the 13.56 MHz harmonic to decrease (e.g., by connecting the filter 1302) while causing the power at the 27.12 MHz harmonic to increase (e.g., by shorting the filter 1306). This is shown in the graph 1400 may the lower power level at the 13.56 MHz harmonic and the higher power level at the 27.12 MHz harmonic.

In some embodiments, modulating multiple different harmonics of the reflected signal in a complementary fashion as illustrated in the graph 1400 may allow for a relative, rather than absolute, threshold when measuring the power of the harmonics. As additional noise will tend to raise the power of all harmonics in the reflected signal (such as the reflected signal illustrated in FIG. 14), the use of relative thresholds may provide for higher noise immunity. In some embodiments, the transmitter 400 may determine the value of symbols transmitted via the in-band signal from the receiver 1300 using a ratio between the power levels at two or more different harmonics (e.g., the 13.56 MHz and 27.12 MHz harmonics as illustrated in FIG. 14), instead of the power level of a single harmonic. This may improve detectability and accuracy of the signaling. In other embodiments, the receiver 1300 may modulate multiple harmonics in order to increase signaling rate (e.g., the 13.56 MHz harmonic being used to transmit a first bit of information, and the 27.12 MHz harmonic being used to transmit a second bit of information).

FIG. 15 shows another graph 1500 of power levels at various harmonic frequencies in a reflected signal modulated by the receiver 1300 of FIG. 13. The graph 1500 comprises an x-axis corresponding to frequency in MHz and a y-axis corresponding to power level. Similar to the reflected signal illustrated in FIG. 6, the modulated reflected signal may have a highest amount of power at the fundamental frequency of 6.78 MHz, as well as lower amounts of power at each of the harmonic frequencies of 13.56 MHz, 20.34 MHz, 27.12 MHz, and 33.9 MHz. The two arrows at the 13.56 MHz harmonic, the 20.34 MHz harmonic, and the 27.12 MHz harmonic illustrate different levels of power that may be at the harmonics, based upon the modulation performed by the receiver 1300.

As illustrated in the graph 1500, more than one harmonic of the reflected signal may be modulated. In this example, the receiver 1300 modulates three harmonics of the reflected signal (e.g., at 13.56 MHz, 20.34 MHz, and 27.12 MHz). For example, the receiver 1300 may signal a first “1” or “0” bit by modulating the 13.56 MHz harmonic (shown in the graph 1500 by a higher power level at the 13.56 MHz harmonic corresponding to a “1” value, and a lower power level at the 13.56 MHz harmonic corresponding to a “0” value). Similarly, the receiver 1300 may signal second and third “1” or “0” bits by modulating the 20.34 MHz and 27.12 MHz harmonics respectively (shown in the graph 1500 by higher levels of power at the 20.34 MHz and 27.12 MHz harmonics as corresponding to “1” values for the second and third signal bits, and lower levels of power at the 20.34 MHz and 27.12 MHz harmonics as corresponding to the “0” values for the second and third signal bits).

By modulating three different harmonics, the receiver 1300 may be able to signal to the transmitter 400 three bits of data transfer for each modulation period, potentially increasing signal throughput by a factor of 3. Alternatively, the receiver 1300 may use one or more of the modulated harmonics to implement error correcting codes, which can be used to improve signaling accuracy (e.g., via a checksum, Hamming code, Reed-Solomon code, and/or the like).

### Sub-Harmonic Load Modulation

While the above describes in-band signaling by manipulating power levels at different harmonics in the reflected signal, in some embodiments, the receiver 500 may perform in-band signaling by imposing a load on the reflected signal at a frequency that is lower than the fundamental. As discussed above with respect to the graph 600 illustrated in FIG. 6, in some embodiments the reflected signal will typically have no power below the fundamental frequency. Therefore, modulating the reflected signal to apply a load at a frequency below the fundamental frequency may result in power at the modulated frequency that is easy for the transmitter 400 to detect.

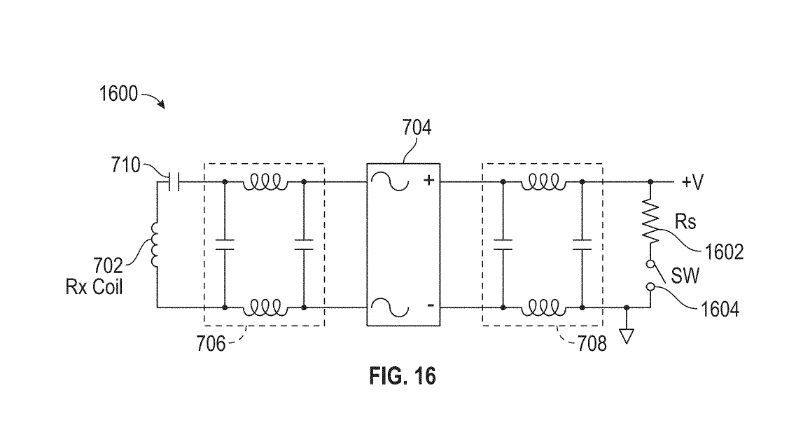

FIG. 16 illustrates a schematic diagram of another exemplary receiver 1600 configured to implement load modulation. The receiver 1600 may be analogous to the receiver 700 as illustrated in FIG. 7, comprising a receiver coil 702, a rectifier 704, and one or more filters 706 and 708. The receiver 1600 may comprise a load 1602 (e.g., implemented as a resistor Rs) that may be switched in and out of the output of the rectifier 704 by the controller 516 (e.g., by opening and closing a switch 1604) at a period that is a multiple of the fundamental, in accordance with some embodiments. As illustrated in FIG. 16, the load 1602 and switch 1604 may be in parallel with the receiver antenna 702 and be positioned after the filter 708.

For example, in some embodiments, the controller 516 may switch the switch 1604 at a rate that is half that of the fundamental frequency. As such, for a fundamental frequency of 6.78 MHz, the switch 1604 may be opened and closed based upon a 3.39 MHz frequency.

The load Rs 1602 may comprise a signaling resistor that provides a signaling load on the reflected signal. In some embodiments, the load Rs 1602 is configured to have a small enough resistance that the signaled load change can be easily detected by the transmitter 400, but not so small that a significant amount of power is dissipated (since any power dissipated by the load Rs 1602 is then not usable by the load 550). In some embodiments, the load 1602 may comprise a variable resistor, allowing for different load amounts to be switched in and out, which may potentially be used to increase a number of symbols that can be output through the transmitted signal. For example, the load Rs 1602 may be configured to have a first load value that corresponds to a first symbol value, and a second different load value corresponding to a second symbol value.

While FIG. 16 illustrates the load 1602 and its associated switch 1604 placed at a particular location in the signal chain of the receiver 1600, it is understood that the load 1602 and its associated switch 1604 may be placed anywhere in the signal chain shown, such as before the first filter 706, after the first filter 706 but before the rectifier 704, after the rectifier 704 but before the second filter 708, or after the second filter 708 (as shown.) The location of the load 1602 and the switch 1604 may be determined based upon a size of a filter capacitor on the +V output of the filters 706 and 708, and/or EMI concerns with the filters 706 and 708.

Alternatively, in some embodiments, the load 1602 may comprise a useful load, such as a backlight or intermittent battery charger (not shown). In some embodiments, a battery charger can be cycled through two different power levels (corresponding to different values of the load 1602) to provide a subharmonic load change.

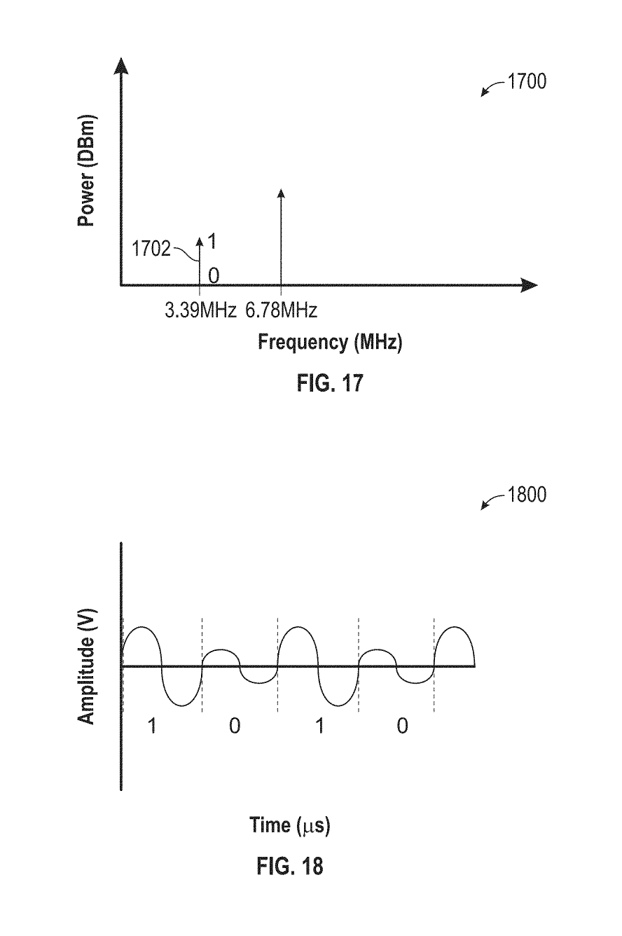

FIG. 17 shows graph 1700 of power levels at various frequencies in a modulated reflected signal between the transmitter 400 and the receiver 1600 of FIG. 16 (frequencies above the fundamental not shown). The graph 1700 shows an x-axis corresponding to frequency in MHz and a y-axis corresponding to power level of the reflected signal. As illustrated in the graph 1700, the reflected signal comprises power at the 6.78 MHz fundamental frequency. In addition, except for the signal 1702 (discussed in greater detail below), there may be no power in the reflected signal at frequencies below the fundamental.

To modulate the reflected signal to signal a “1” bit, the load 1602 may be applied on the receiver 1600 every other cycle of the fundamental frequency (e.g., using the switch 1604). This imposes a load signal 1702 on the reflected signal having half the frequency of the fundamental frequency (e.g., 3.39 MHz, which is half of the 6.78 MHz fundamental frequency). Due to nonzero impedances in the transmitter 400 and finite coupling between transmitter 400 and receiver 1600, the imposed load 1602 generates the signal 1702 in the reflected signal at the new frequency (3.39 MHz) that is half the original fundamental frequency of 6.78 MHz. Since there is no other power at this frequency, the signal 1702 at the new frequency of 3.39 MHz may be easy to detect by the transmitter 400. On the other hand, when the load 1602 is not applied on the receiver 1600 (e.g., the switch 1604 remains open), the signal 1702 may have no power, and a “0” bit is signaled.

FIG. 18 shows a graph 1800 of amplitude over time of an exemplary modulated reflected signal between the transmitter 400 and the receiver 1600 of FIG. 16, in accordance with some embodiments. The graph 1800 shows an x-axis indicating time in μs, and a y-axis indicating amplitude in volts. The periods of the modulated reflected signal of FIG. 18 are shown separated by dashed lines.

Similar to the graph 1200 of FIG. 12, the reflected signal in the graph 1800 may be substantially sinusoidal. When the reflected signal is modulated by the receiver 1600, the resulting signal may exhibit a change in the amplitude reflected signal occurring at an integer ratio of the fundamental frequency (e.g., 2× the fundamental). For example, as illustrated in FIG. 18, the modulated reflected signal may have periods of higher amplitude and periods of lower amplitude, wherein the periods of higher amplitude may correspond to a signaled “1,” and the period of lower amplitude may correspond to a signaled “0.”

In some embodiments, the lower amplitude of the reflected signal, as illustrated in FIG. 18, may represent a zero value, while the higher amplitude may represent a one value, although those decisions are arbitrary. In general, if a dissipative resistive load 1602 is used, the “load on” state of the receiver 1600 may be minimized in order to avoid wasting power.

### Phase Signaling

An alternative to load signaling is to change the phase of the reflected signal, which may be accomplished in several ways.

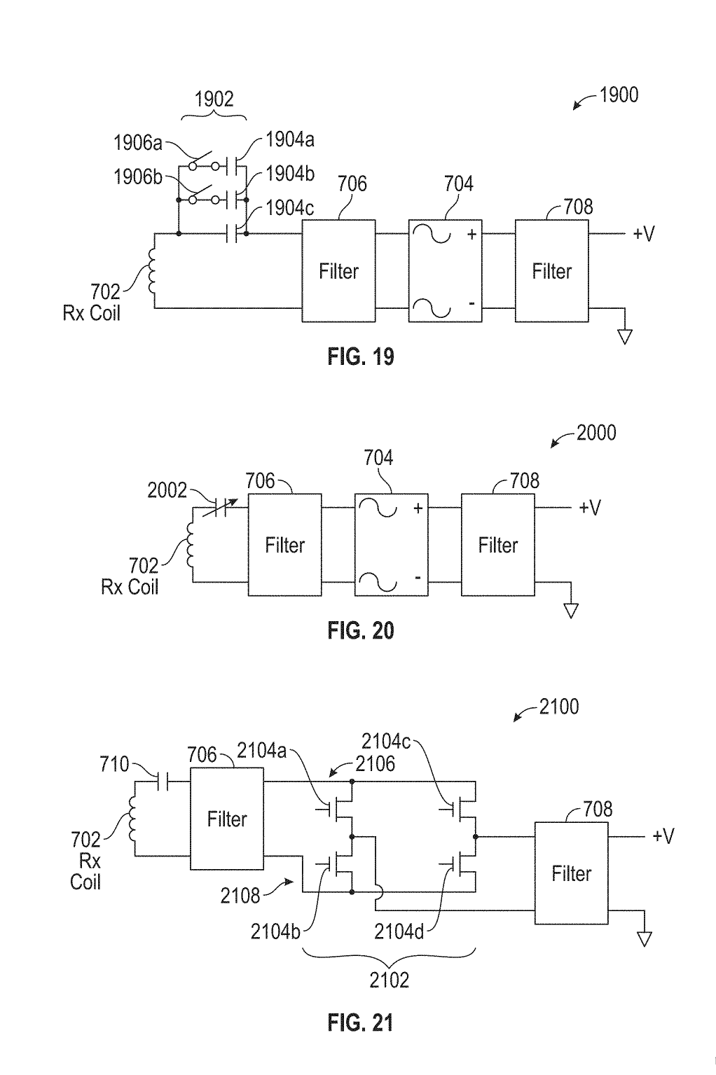

FIG. 19 illustrates a schematic diagram of another exemplary receiver 2000 configured to be able to change a phase of the reflected signal. The receiver 1900 comprises a receiver coil 702, rectifier 704, and filters 706 and/or 708, similar to the receiver 700 of FIG. 7. In addition, the receiver 1900 may comprise a tuning capacitor 1902 in place of or in addition to the tuning capacitor 710 of the receiver 700.

In some embodiments, the phase of the reflected signal from the receiver 1900 to the transmitter 400 may be based upon an imaginary impedance component of the receiver 1900. The receiver 1900 may have an impedance with a real component (e.g., resistance) and an imaginary component (e.g., also referred to as reactance, and defined by the inductance and capacitance of the receiver 1900). For example, as discussed above, the load 1602 may be connected to the receiver 1600 to change a resistance of the receiver 1600. Similarly, the tuning capacitor 1902 may be configured to change an imaginary impedance component of the receiver 1900, which is defined by the inductance of the receiver coil 702 and the capacitance of the tuning capacitor 1902.

In some embodiments, the receiver 1900 may change the phase of the reflected signal by switching the tuning capacitor 1902 above or below resonance. For example, the tuning capacitor 1902 may be tuned such that the impedance of the receiver 1900 is at resonance (no imaginary part to the impedance), below resonance (increasing imaginary part of the impedance in a first direction), or above resonance (increasing imaginary part in the opposite direction). Thus, in embodiments where the transmitter 400 is able to detect a phase of the reflected signal, the receiver 1900 may adjust the phase of the reflected signal may allow for three levels of signaling (e.g., at resonance, below resonance, or above resonance). The use of trinary, or three-signal, signaling, may improve signaling speeds, while maintaining a zero average imaginary impedance of the receiver 1900. In addition, by having an average imaginary impedance of zero, the design of the transmitter 400 may be simplified, since the load seen by the transmitter 400 will be more resistive.

In some embodiments, the tuning capacitor 1902 comprises a plurality of capacitors 1904a, 1904b, and 1904c, and a plurality of switches 1906a and 1906b that may be used to connect or disconnect capacitors 1906a and 1906b from the receiver 1900. By configuring the switches 1906a and 1906b, the impedance of the tuning capacitor 1902 may be configured such that the phase of the reflected signal from the receiver 1900 will be at, above, or below resonance, depending upon which of the capacitors 1906a and 1906b are connected to the receiver 1900. For example, when none of the switches 1906a and 1906b are closed, the receiver 1900 may be above resonance. When one switch 1906a or 1906b is closed, the receiver 1900 may be at resonance. When two switches 1906a and 1906b are closed, the receiver 1900 may be below resonance.

FIG. 20 illustrates a schematic diagram of another exemplary receiver 2000 where the phase of the reflected signal can be changed using a variable capacitor 2002 (e.g., a transcap or a varactor). Like receivers 700 and 1900, the receiver 2000 comprises a receiver antenna 702, rectifier 704, and filters 706 and/or 708. In addition, the receiver 2000 comprises the variable capacitor 2002 in place of or in addition to the tuning capacitors 710 and/or 1902.

The variable capacitor 2002 may be used to tune the receiver 2000 by varying a reactance of the receiver 2000. For example, the controller 516 may tune the variable capacitor 2002 over different capacitance values to achieve multiple levels of signaling based upon the reactance of the receiver 2000. In some embodiments, the variable capacitor 2002 may be tuned such that the receiver 2000 may achieve different levels of impedance (e.g., very inductive, slightly inductive, purely real, slightly capacitive and very capacitive—thus allowing five symbols per bit time). In some embodiments, different levels of impedance corresponding to different levels of signaling may be used to transmit different symbols from the receiver 2000 to the transmitter 400 via the reflected signal.

### Phase Signaling Through Rectifier Drive Signals

In some embodiments, phase signaling may be performed using rectifier drive signals.

FIG. 21 illustrates a schematic diagram of an exemplary receiver 2100 comprising a synchronous rectifier 2102, in accordance with some embodiments. Similar to the receiver 700, the receiver 2100 may comprise a receiver antenna 702, filters 706 and/or 708, and tuning capacitor 710. In addition, the synchronous rectifier 2102 of the receiver 2100 may correspond to the rectifier 704 illustrated in FIG. 7. The synchronous rectifier 2102 may comprise two branches, a first branch comprising switches 2104a and 2104b, and a second branch comprising switches 2104c and 2104d.

The synchronous rectifier 2102 may be operated between two states—a first state when switches 2104b and 2104c are closed, and a second state when switches 2104a and 2104d are closed. The two states may be referred to hereafter as states BC and AD, respectively, which represent which switches of the rectifier 2102 are closed during the respective state (e.g., switches 2104b and 2104c being closed corresponding to state BC, and switches 2104a and 2104d being closed corresponding to state AD). In some embodiments, states BD (switches 2104b and 2104d closed at the same time) and AC (switches 2104a and 2104c closed at the same time) may also be achieved.

The synchronous rectifier 2102 may be driven by the controller 516 using a signal that causes the rectifier 2102 to alternate between states BC and AD. Normally, the controller 516 may synchronize the signal to the incoming waveform of the wireless field 205. This represents a case close to resonance, or close to zero imaginary impedance, and may be referred to as the “normal” drive signal. In some embodiments, the controller 516 may change the phase of the reflected signal by driving the synchronous rectifier 2102 of the receiver 2100 (e.g., to switch between the BC and AD states) with a phase shifted signal (e.g., leading or lagging the “normal” drive signal).

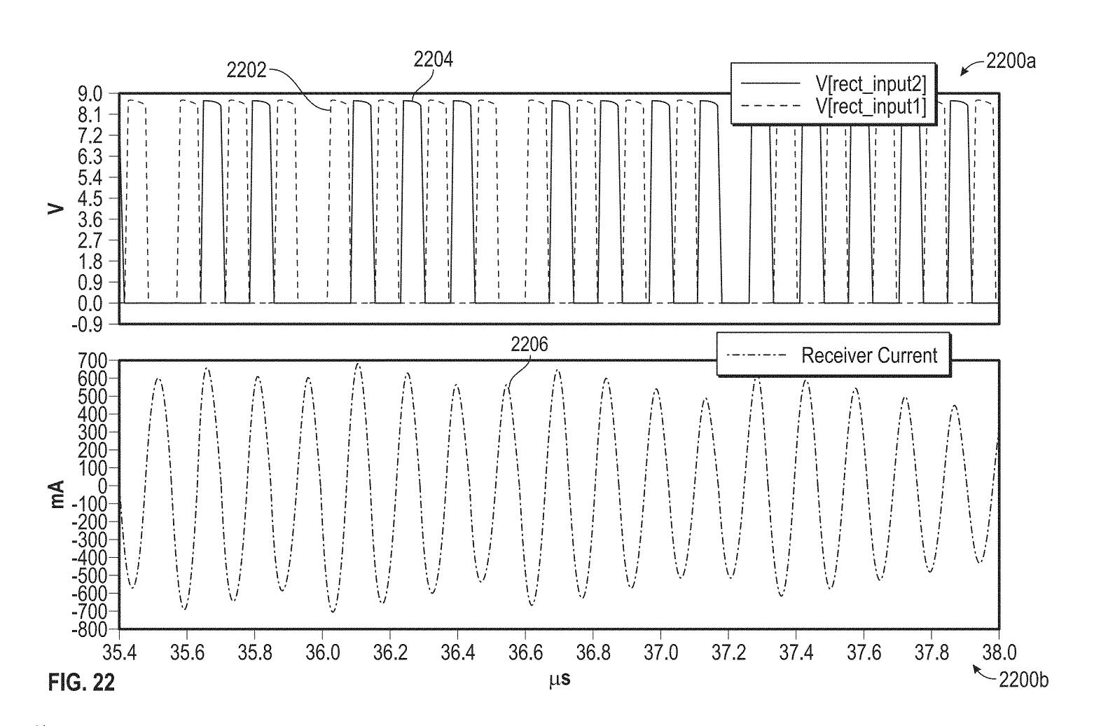

FIG. 22 shows graphs 2200a and 2200b of voltage values at the inputs of the rectifier 2102 of FIG. 21 over time, and current values at the receive coil 702 over time, in accordance with some embodiments. The graph 2200a shows an x-axis corresponding to time in μs and a y-axis corresponding to voltage. The first trace 2202 and the second trace 2204 of the graph 2200 may correspond to voltages at points 2106 and 2108 the AC input side of the synchronous rectifier 2102 (as illustrated in FIG. 21). The first and second traces 2202 and 2204 may have shapes similar to square waves.

The graph 2200b shows an x-axis correspond to time in μs and a y-axis corresponding to current in mA. The third trace 2206 of the graph 2200b corresponds to the current at the receiver coil 702 (e.g., received via the wireless field 205). As shown by the third trace 2206, the current may be substantially sinusoidal, but may carry one or more subharmonic frequencies in addition to the fundamental. In some embodiments, the subharmonic frequencies of the third trace 2206 may be caused by the controller 516 shorting the rectifier 2102 over one or more cycles (discussed in greater detail below).

Switching of the switches 2104a-d may occur periodically within the rectifier 2102. For example, when the first trace 2202 is high (e.g., ˜8-9V), the rectifier 2102 is in the BC state. When the second trace 2204 is high, the rectifier 2102 is in the AD state. Both first and second traces 2202 and 2204 being low indicate that the rectifier 2102 is in the BD state. As shown in FIG. 22, the rectifier 2102 may be driven such that it switches states substantially synchronously with the received AC current at the receive coil 702.

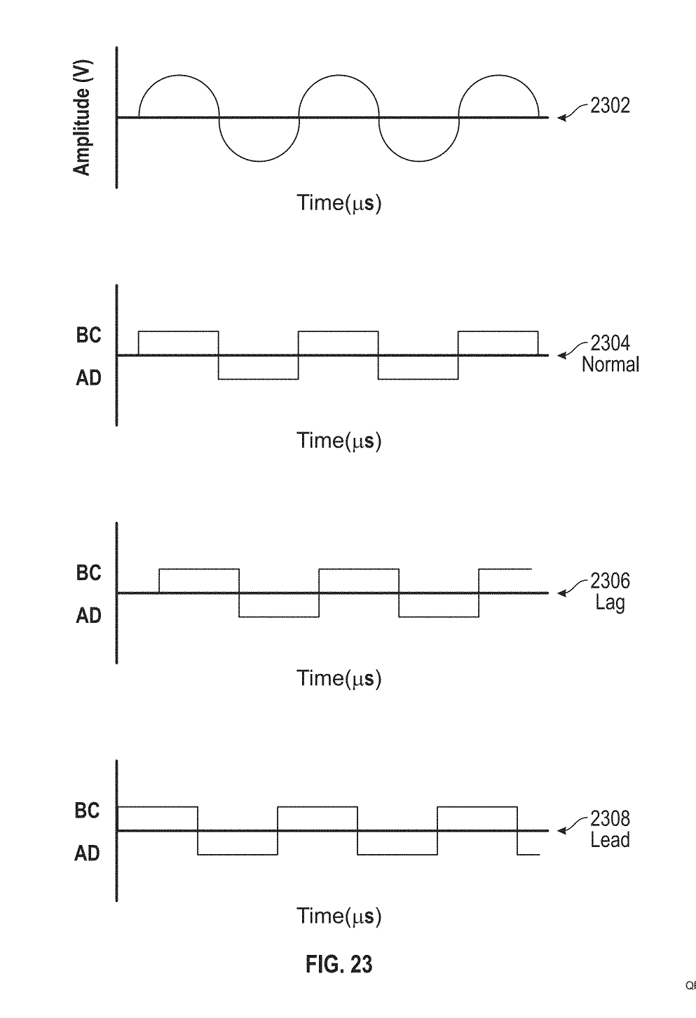

FIG. 23 illustrates examples of different drive signals that may be used to drive the synchronous rectifier 2102 relative to an incoming signal 2302 from the transmitter 400 to the receiver 2100. The incoming signal 2302 may correspond to a signal transmitted from the transmitter 400 to the receiver 2100, and is illustrated with time in μs on the x-axis and amplitude in volts on the y-axis. In some embodiments, the incoming signal 2302 may be received by the receiver 2100 via the wireless field 205.

The synchronous rectifier 2102 of the receiver 2100 may be driven using a normal drive signal 2304, a lagging drive signal 2306, or a leading drive signal 2308. For example, the normal drive signal 2304 may switch between the BC and AD states (illustrated in FIG. 23 as a square wave) substantially synchronously with the incoming signal 2302 (e.g., each state change in the normal drive signal 2304 is substantially synchronous with a zero voltage crossing of the incoming signal 2302). On the other hand, the lagging drive signal 2306 may lag the incoming signal 2302, where each state change lags a corresponding zero voltage crossing of the incoming signal 2302. The leading drive signal 2308 may lead the incoming signal, where each state change leads a corresponding zero voltage crossing of the incoming signal 2302.

Under normal operation, where the controller 516 drives the sync rectifier 2102 using the normal drive signal 2304, the sync rectifier 2102 switches between the states BC and AD substantially synchronously with the incoming transmitter signal 2302. On the other hand, driving the sync rectifier 2102 using the lagging drive signal 2306 will force the sync rectifier 2102 to switch later than the incoming signal 2302 would dictate. This may result in a lagging reflected signal and the receiver 2100 having a negative imaginary impedance. In the opposite case, when the sync rectifier 2102 is driven using the leading drive signal 2308, the sync rectifier 2102 will switch earlier than it would normally, resulting in a leading reflected signal and the receiver 2100 having a positive imaginary impedance. As with switching a tuning capacitor (e.g., tuning capacitor 1902 or 2002) to tune above or below resonance, this may result in a trinary modulation scheme.

In some embodiments, the controller 516 may drive the sync rectifier 2012 using a drive signal that lags the incoming signal (e.g., lagging drive signal 2306), in order to force zero voltage switching (ZVS) of the switches of the rectifier 2102 (which may be implemented as MOSFETs). ZVS switching may reduce noise and losses of the rectifier 2102. For example, in some embodiments there may be some dead time between states BC and AD of the rectifier 2102. Under a ZVS condition, the incoming signal waveform 2302 may cause the voltage at the input of the rectifier 2102 (e.g., at points 2106 and 2108) to swing on its own. This may cause a switch 2104A, 2104B, 2104C, or 2104D to turn on when the voltage from drain to source of the switch reaches zero. An amount of lag between the incoming signal waveform and rectifier drive signal may determine when ZVS occurs. For example, a larger lag of lagging drive signal 2306 and more current at the receive coil 702 may tend to force ZVS to occur sooner. On the other hand, in some embodiments, when the rectifier 2102 leads the incoming signal (e.g., the rectifier 2102 is driven by leading drive signal 2308), there may be “hard switching” causing losses. In some embodiments, the controller 516 may drive the sync rectifier 2012 using a drive signal with a small amount of lag relative to the incoming signal for ZVS purposes, and may drive the sync rectifier 2012 using a drive signal with a larger amount of lag relative to the incoming signal for signaling purposes as described above.

In some cases, the controller 516 may short the rectifier 2102 for occasional cycles of the incoming signal waveform 2302 (by turning on switches 2102A and 2102C at the same time, or switches 2102B and 2102D at the same time). In some embodiments, the rectifier 2102 may be shorted for part of a single cycle of the incoming signal waveform 2302, or for a half or a full cycle at a time. Because the rectifier 2102 may be driven by a series resonant tank (e.g., comprising the receive coil 702 and tuning capacitor 710), shorting the rectifier 2102 may cause current (and energy) to build up in the tank, which may be released when the rectifier 2102 is in a non-shorted state. In some embodiments, this release may take several cycles, depending on an amount of energy that is stored and the loaded charge (Q) of the tank. In some embodiments, the rectifier 2102 may be shorted for a single full cycle of the incoming signal waveform 2302, with the next cycle being “normal.” This may produce a ½ subharmonic (e.g., 3.39 MHz where the fundamental is 6.78 MHz). In some embodiments, different subharmonics may be generated based upon a ratio of shorted cycles of the rectifier 2102 to “normal” cycles. In some embodiments, the generated subharmonic may be used for subharmonic signaling from the receiver 2102 to the transmitter 204.

In some embodiments, shorting the rectifier 2102 does not have a large impact on efficiency, as energy is stored in the series resonant tank (formed by the receiver coil 702 and tuning capacitor 710) during shorted cycles, and is released in subsequent cycles during normal rectifier operation. In some embodiments, the controller 516 may short the rectifier 2102 in order to cause a dramatic change in impedance (it is close to a dead short) that can be used to implement subharmonic modulation. In addition, in some embodiments, shorting and then discharging the LC tank circuit may boost the voltage output by the rectifier 2102 during normal rectifier operation, which may compensate for low voltages at the receive coil 702. By boosting the output voltage of the rectifier 2102, operation may be allowed when the voltage at the receive coil 702 may be too low otherwise.

### Combined Phase/Amplitude Shifting

In some embodiments, both load signaling (e.g., as illustrated in FIG. 16-19) and phase signaling (e.g., as illustrated in FIG. 19-20 and FIGS. 21-23) can be combined to produce a larger constellation of symbols that can be transmitted through the reflected signal.

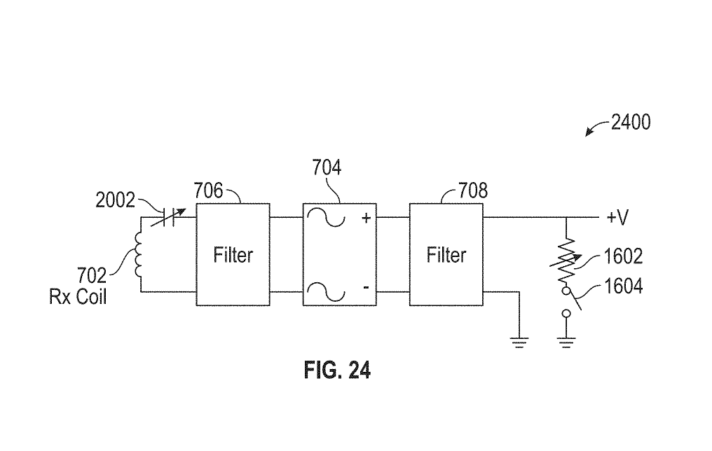

FIG. 24 illustrates a schematic diagram of another exemplary receiver 2400 configured to implement combined signaling, in accordance with some embodiments. Similar to the receiver 700 illustrated in FIG. 7, the receiver 2400 comprises a receiver antenna 702, rectifier 704, and filters 706 and/or 708. The receiver 2400 comprises an apparatus for changing a phase of the reflected signal by changing an imaginary impedance of the receiver 2400 (variable capacitor 2002, such that as illustrated in FIG. 20) and an apparatus for generating a subharmonic load on the reflected signal by changing a real resistance of the receiver (variable load 1602 that may be switched on and off using switch 1604, such as that illustrated in FIG. 16), which can be used together to generate subharmonic modulation. In some embodiments, the controller 516 may vary the capacitance of the receiver 2400 using the variable capacitor 2012 (e.g., a transcap) to achieve a plurality of different phase deltas. In addition, the controller 516 may vary the real resistance of the receiver 2400 using the variable resistance 1602 and switch 1604 to achieve a plurality of different resistance deltas. The variable capacitor 2012, variable resistance 1602, and switch 1604 may be under control of a microcontroller (e.g., controller 516) in the receiver 2400. Using both load signaling and phase signaling may allow for a significant increase in number of symbols that may be transmitted in the reflected signal, and hence an increase in an amount of data that can be transferred per bit time.

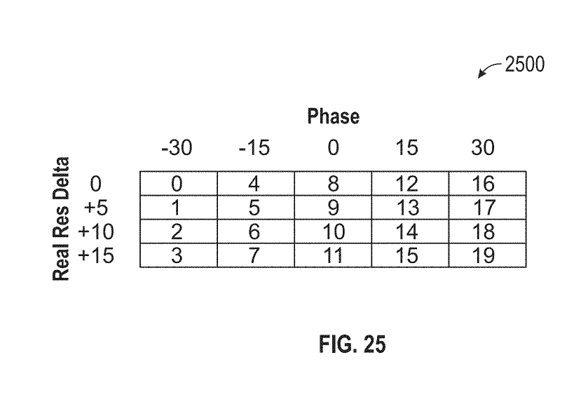

FIG. 25 shows a table 2500 showing possible symbol combinations that may be achieved by the receiver 2400 of FIG. 24 using combined signaling. As discussed above, in some embodiments, the receiver 2400 may configure the resistance of the variable resistor 1602 to achieve multiple resistance deltas, and configure a capacitance of the variable capacitor 2012 to achieve multiple phase deltas. In the illustrated table, each row corresponds to a different resistance delta received by varying a resistance value at the receiver 2400 (e.g., using the variable resistor 1602), while each column corresponds to a different phase delta that can be achieved by varying the capacitance of the receiver 2400 (e.g., using the variable capacitor 2012). For example, the variable resistor may be able to be varied between 5 kΩ, 10 kΩ, 15 kΩ, and 0 k Ω (corresponding to when the variable resistor 1602 is disconnected from the receiver 2400 by opening the switch 1604), allowing for four different resistance deltas. The variable capacitor 2002 may be able to be configured between five different capacitance values corresponding to a 0° phase shift, ±15° phase shift, and ±30° phase shift. The combination of four resistance deltas and five phase deltas allows for 20 symbols per bit time. This equates to 4.3 bits per bit time.

In some embodiments, subharmonics (e.g., such as those created through load modulation using the variable resistance 1602 and switch 1604) can themselves create harmonics, so management of harmonics may be important from an EMI perspective. For example, a divide by 3 from a 6.78 MHz signal will produce a frequency of 2.26 MHz, with harmonics at 4.52 MHz, 9.04 MHz etc. These harmonics may need to be taken into account from an EMI perspective.

In some embodiments, a microcontroller is used to drive the switches/variable caps/variable resistors to generate the signaling.

### Use of Wireless Power Fundamental for Communication Frequency

Some wireless power receivers may have difficulty generating an accurate frequency due to their small size (e.g., when installed in medical implants or other compact devices). In many embodiments, the small size may prevent use of crystals, ceramic oscillators, or other accurate frequency-generating devices. Lack of accurate frequencies may further prevent such devices from meeting various requirements for signal frequencies and bandwidths. Furthermore, accurate frequency-generating devices may increase costs of the wireless power receivers.

In some embodiments, these wireless power receivers may communicate using accurate frequencies by using a fundamental power transmission frequency to generate the reference from the wireless power receiver communications. Accordingly, the accuracy of a communications transmission of the wireless power receiver is linked to the accuracy of the fundamental power transmission frequency. As the fundamental power transmission frequency may be generated by a large external transmitter which utilizes an accurate crystal or other accurate frequency source to maintain any desired standard of accuracy.

In some embodiments, the divide-by-2 ratio described above may be used to allow subharmonic signaling for the wireless power receivers. However, dependent on the fundamental power transmission frequency, the resulting subharmonic may be outside a bandwidth of a receive circuit of the wireless power receiver (e.g., the resonator of the receive circuit), which may not permit use of the receive circuit of the wireless power receiver as a transmitter. However, a different ratio may be selected. For example, a M/N frequency synthesizer or a phase locked loop may be used to generate at other frequency percentages of the fundamental power transmission frequency, e.g., 90% of the fundamental. The ability to limit the frequency percentage of the fundamental when generating the communication transmission frequency for the wireless power transmitter may allow the receive circuit of the wireless power receiver to be used for wireless power reception and data use. Thus, the generated frequencies based on the wireless power transmitter frequencies are more likely to be inside the bandwidth of the resonator of the receive circuit of the wireless power receiver.

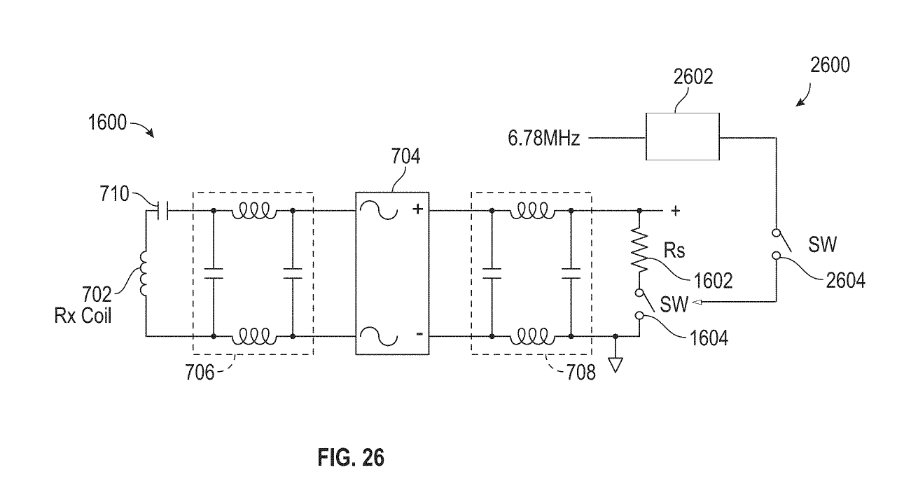

FIG. 26 shows a schematic diagram of a frequency modulation circuit of an exemplary receiver 1600 of FIG. 16 configured to perform frequency modulation. The frequency modulation circuit 2600 may include the hardware of the receiver 1600 (FIG. 16) with additional hardware that switches a load in and out of the rectifier output of the receiver 1600. The frequency modulation circuit 2600 may include an M/N frequency synthesizer 2602 (e.g., the M/N divider 2602) and a modulation switch 2604. The resulting modulation signals may be applied to or used to control the switch 1604 (FIG. 16).

For example, the frequency modulation circuit 2600 may divide a 6.78 MHz fundamental frequency (e.g. as received by the RX coil) by 10/9 (resulting in a 6.102 MHz signal) and apply the result to the switch 1604. The signal output by the frequency modulation circuit 2600 may be controlled by the modulation switch 2604 (e.g., controlled by a frequency modulator). Such control by the modulation switch 2604 may result in a corresponding “on-off' keying of the communications signal. The load 1602 may be a signaling resistor that provides the signaling load. The load 1602 may be configured to ensure that the load change is easily seen. The load 1602 should also be configured to ensure that a significant amount of power is not dissipated by the load 1602 (e.g., minimize unusable power loss by the load 1602).

In some embodiments, the load 1602 may alternatively or additionally be replaced with a useful load, such as a backlight or intermittent battery charger. Alternatively, or additionally, the load 1602 could be cycled through two different power levels to provide the subharmonic load change.

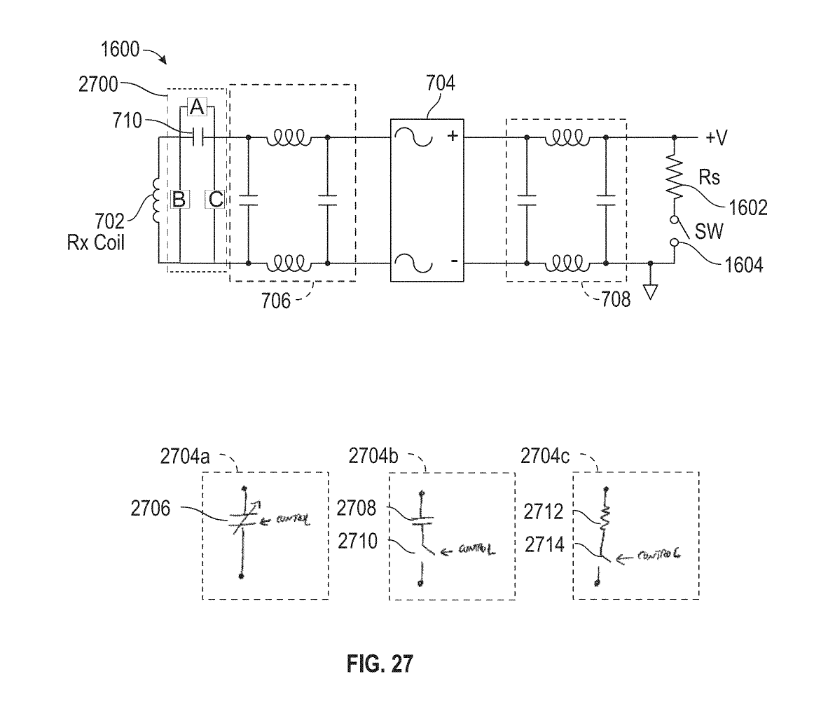

FIG. 27 shows a schematic diagram of a frequency modulation circuit 2700 as integrated into an exemplary receiver 1600 of FIG. 16 configured to perform frequency modulation. The frequency modulation circuit 2700 may be positioned at any one or more of the positions A, B, or C in the receiver 1600 of FIG. 16. The frequency modulation circuit 2700 may provide any alternative or additional tuning or loading option of the receiver 1600 at a position nearer the receiver antenna 702. In some embodiments, portions of the circuitry of the receiver 1600 nearer the receiver antenna 702 may be more sensitive to frequency modulations (and result in higher EMI risks). However, greater levels of frequency modulation may be achieved at the positions A, B, or C since the frequency modulation circuit 2700 affects the LC resonator circuit (comprising the receiver antenna 702 and the tuning capacitor 710) directly.

In any one of the positions A, B, or C identified in FIG. 27, several possibilities for tuning/loading circuits 2704a-2704c for use as the frequency modulation circuit 2700 are provided. Any of the tuning/loading circuits 2704a-2704c may be placed in any of the positions A, B or C in the receiver 1600.

A first tuning/loading circuit 2704a may include a variable capacitor (e.g., transcap) 2706. The transcap 2706 may comprise a capacitor that may be electrically tuned to a new value. In some embodiments, the transcap 2706 may be dynamically tuned. The electrical tuning may comprise adjusting any one or more parameters of the transcap 2706 (e.g., the tuning voltage, etc.). For example, making a step change in the tuning voltage of the transcap 2706 may either tune or untune the receiver 1600. Such change in the tuning of the receiver 1600 may cause a change in a complex impedance of the receiver 1600 (e.g., due to moving away from a resonant peak of the receiver 1600). The change in the tuning of the receiver 1600 may also cause a change in a load of the receiver 1600 (e.g., due to a reduction in coupling).

A second tuning/loading circuit 2704b may include a switched capacitor comprising a combination of a capacitor 2708 and a control switch 2710. The combined switched capacitor may be configured to have many of the effects of the transcap 2706.

A third tuning/loading circuit 2704c may include a resistive load comprising a resistor 2712 (as shown) and a control switch 2714. The combined resistive load may result primarily in real resistance changes in the receiver 1600.

Positions A, B, and C are examples of positions where any of the tuning/loading circuits 2704a-2704c may be placed in the receiver 1600. For example, position A may comprise one of the tuning/loading circuits 2704a-2704c being positioned around the tuning capacitor 710. For example, position B may comprise one of the tuning/loading circuits 2704a-2704c being positioned across the receiver antenna 702. For example, position B may comprise one of the tuning/loading circuits 2704a-2704c being positioned across the output of the LC resonator circuit comprising the receiver antenna 702 and the tuning capacitor 710.

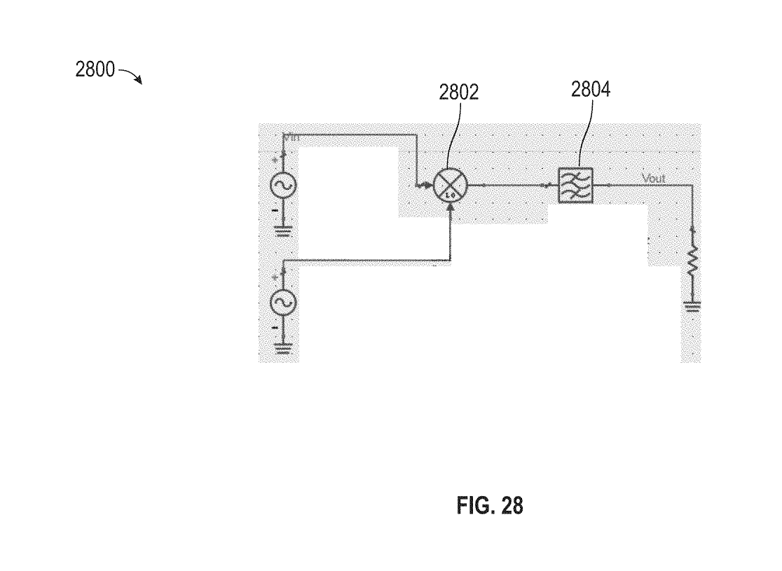

FIG. 28 shows a schematic diagram of an exemplary mixer circuit 2800 configured to perform frequency modulation. Alternatively, or additionally, the mixer circuit 2800 can be utilized to generate a low harmonic or subharmonic. For example, the mixer circuit 2800 may include a mixing component 2802 having a first input frequency of 6.78 MHz and a second input frequency of 5 MHz. The mixing component 2802 may down-convert the 6.78 MHz first input frequency based on the 5 MHz second input frequency to generate a fundamental frequency to 1.78 MHz. Other harmonics or subharmonics of the input frequencies can be significantly attenuated by a bandpass filter, e.g., bandpass filter 2804. An example of an advantage of the exemplary mixer circuit 2800 is ease of build and implementation. In some embodiments, any frequency of down-conversion may be chosen.

Note that the frequency accuracy of this may be lower due to the lack of accurate references in the wireless power receiver. However, since the overall accuracy is a product of both the fundamental and the local oscillator, accuracy is still higher than a single oscillator would be.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and method steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose hardware processor, a Digital Signal Processor (DSP), an Application Specified Integrated Circuit (ASIC), a Field Programmable Gate Array (FPGA) or other programmable logic device, discrete gate or transistor logic, discrete hardware components, or any combination thereof designed to perform the functions described herein. A general purpose hardware processor may be a microprocessor, but in the alternative, the hardware processor may be any conventional processor, controller, microcontroller, or state machine. A hardware processor may also be implemented as a combination of computing devices, e.g., a combination of a DSP and a microprocessor, a plurality of microprocessors, one or more microprocessors in conjunction with a DSP core, or any other such configuration.

The steps of a method and functions described in connection with the implementations disclosed herein may be embodied directly in hardware, in a software module executed by a hardware processor, or in a combination of the two. If implemented in software, the functions may be stored on or transmitted as one or more instructions or code on a tangible, non-transitory computer readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the hardware processor such that the hardware processor can read information from, and write information to, the storage medium. In the alternative, the storage medium may be integral to the hardware processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The hardware processor and the storage medium may reside in an ASIC.

For purposes of summarizing the disclosure, certain aspects, advantages and novel features s have been described herein. It is to be understood that not necessarily all such advantages may be achieved in accordance with any particular implementation. Thus, the disclosure may be embodied or carried out in a manner that achieves or optimizes one advantage or group of advantages as taught herein without necessarily achieving other advantages as may be taught or suggested herein.

Various modifications of the above-described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. An apparatus for receiving wireless power, the apparatus having an impedance comprising a resistive component and a reactance component, the apparatus comprising:
an antenna circuit configured to receive power from a wireless charging field generated by a power transmitter and to generate a reflected signal based on the power received from the wireless charging field, the reflected signal having a fundamental frequency; and
a control circuit coupled to the antenna circuit and configured to transmit a symbol to the power transmitter based on either changing:
a power level of the reflected signal at one or more frequencies different from the fundamental frequency of the reflected signal, or
a phase of the reflected signal.

2. The apparatus of claim 1, wherein the control circuit is configured to change the power level of the reflected signal by varying the resistive component of the impedance.

3. The apparatus of claim 1, wherein the control circuit is configured to connect and disconnect a resistive component to the antenna circuit at a rate based upon a first frequency less than the fundamental frequency to increase the power level of the reflected signal at the first frequency.

4. The apparatus of claim 3, wherein the resistor comprises a variable resistor, and wherein the control circuit is configured to vary a resistance of the variable resistor based upon the symbol to be transmitted.

5. The apparatus of claim 1, wherein the control circuit is configured to change the phase of the reflected signal by varying the reactance component of the impedance.

6. The apparatus of claim 1, wherein the antenna circuit further comprises a variable capacitor, and wherein the control circuit is configured to change the phase of the reflected signal by varying a capacitance of the variable capacitor.

7. The apparatus of claim 1, wherein the antenna circuit further comprises a rectifier circuit, and wherein the control circuit is configured to change the phase of the reflected signal by changing a phase of a drive signal of the rectifier circuit.

8. The apparatus of claim 1, wherein the antenna circuit further comprises a rectifier circuit, and wherein the control circuit is configured to short the rectifier circuit at a first frequency less than the fundamental frequency, to change the power level of the reflected signal at the first frequency.

9. The apparatus of claim 1, wherein the antenna circuit further comprises a rectifier circuit comprising a first branch, a second branch, and a resistive load coupled to the first branch, wherein the resistive load is configured to generate a first harmonic or subharmonic in the reflected signal.

10. The apparatus of claim 1, wherein the antenna circuit further comprises:
at least one filter circuit configured to filter out a first harmonic or subharmonic of the fundamental frequency from the reflected signal;
at least one switching circuit operatively coupled to the at least one filter circuit, and configured to either connect or bypass the at least one filter circuit, wherein bypassing the at least one filter circuit allows power of the first harmonic or subharmonic to be reflected as part of the reflected signal; and
wherein the control circuit is further configured to change the power level of the reflected signal by operating the at least one switching circuit to control an amount of power at the first harmonic or subharmonic of the reflected signal.

11. The apparatus of claim 10, wherein the at least one filter circuit comprises a notch filter corresponding to a particular harmonic of the fundamental frequency.

12. The apparatus of claim 10, wherein:
the at least one filter circuit comprises a first filter circuit configured to filter a first harmonic or subharmonic and a second filter circuit configured to filter a second harmonic or subharmonic, and
wherein the control circuit is configured to transmit the symbol by operating the at least one switching circuit to oppositely connect or bypass the first filter circuit and the second filter circuit.

13. The apparatus of claim 10, wherein:
the at least one filter circuit comprises a first filter circuit configured to filter a first harmonic or subharmonic, a second filter circuit configured to filter a second harmonic or subharmonic, and a third filter circuit configured to filter a third harmonic or subharmonic, and
wherein the symbol comprises a first symbol and a second symbol, and control circuit is configured to operate the at least one switching circuit to connect or bypass the first filter circuit based upon a first symbol, to connect or bypass the second filter circuit based upon a second symbol, and to connect or bypass the third filter circuit based upon a function of the first and second symbols.

14. An apparatus for receiving wireless power, the apparatus comprising:
an antenna circuit configured to receive power from a wireless charging field generated by a power transmitter and to generate a reflected signal based on the power received from the wireless charging field, the reflected signal having a fundamental frequency;
at least one filter circuit configured to filter out at least one harmonic or subharmonic of the fundamental frequency from the reflected signal;
at least one switching circuit operatively coupled to the at least one filter circuit, and configured to either connect or bypass the at least one filter circuit, wherein bypassing the at least one filter circuit allows power of the at least one harmonic or subharmonic to be reflected as part of the reflected signal; and
a control circuit configured to transmit a symbol to the power transmitter by operating the at least one switching circuit to control an amount of power at the at least one harmonic or subharmonic of the reflected signal.

15. The apparatus of claim 14, wherein the at least one filter circuit comprises a notch filter corresponding to a particular harmonic or subharmonic of the fundamental frequency.

16. The apparatus of claim 14, wherein:
the at least one filter circuit comprises a first filter circuit configured to filter a first harmonic and a second filter circuit configured to filter a second harmonic, and
wherein the control circuit is configured to transmit the symbol by operating the at least one switching circuit to oppositely connect or bypass the first filter circuit and the second filter circuit.

17. The apparatus of claim 14, wherein:
the at least one filter circuit comprises a first filter circuit configured to filter a first harmonic or subharmonic, a second filter circuit configured to filter a second harmonic or subharmonic, and a third filter circuit configured to filter a third harmonic or subharmonic, and
wherein the symbol comprises a first symbol and a second symbol, and control circuit is configured to operate the at least one switching circuit to connect or bypass the first filter circuit based upon a first symbol, to connect or bypass the second filter circuit based upon a second symbol, and to connect or bypass the third filter circuit based upon a function of the first and second symbols.

18. The apparatus of claim 14, wherein the antenna circuit further comprises a rectifier circuit comprising a first branch, a second branch, and a resistive load coupled to the first branch, wherein the resistive load is configured to generate a second harmonic or subharmonic in the reflected signal.

19. The apparatus of claim 14, wherein the control circuit is configured to connect and disconnect a resistive component to the antenna circuit at a rate based upon a first frequency less than the fundamental frequency, to increase a power level of the reflected signal at the first frequency.

20. The apparatus of claim 14, wherein the control circuit is further configured to change a phase of the reflected signal by varying a reactance component of an impedance of the antenna circuit.

21. A method for communicating with a wireless power transmitter, the method comprising:
receiving power from a wireless charging field generated by the wireless power transmitter at a fundamental frequency via an antenna circuit of a wireless power receiver;
adjusting one or more switches of a switching circuit to control an amount of power of at least one harmonic or subharmonic of the fundamental frequency for a signal to be reflected to the wireless power transmitter, the at least one harmonic or subharmonic representative of a symbol; and
generating the reflected signal to transmit the symbol to the wireless power transmitter.

22. The method of claim 21, wherein the adjustment of the one or more switches generates the at least one subharmonic at a lower frequency than the fundamental frequency.

23. The method of claim 22, wherein the adjustment of the one or more switches modulates an impedance of the wireless power receiver to generate the at least one subharmonic at the lower frequency than the fundamental frequency.

24. The method of claim 22, wherein the adjustment of the one or more switches comprises shorting a rectifier circuit of the wireless power receiver based on a ratio of shorted cycles and non-shorted cycles to generate the at least one subharmonic at the lower frequency than the fundamental frequency.

25. The method of claim 22, wherein the generated at least one subharmonic at the lower frequency than the fundamental frequency is used for subharmonic signaling from the wireless power receiver to the wireless power transmitter.

26. The method of claim 21, wherein the adjustment of the one or more switches selectively attenuates one or more harmonics of the at least one harmonic or one or more subharmonics of the at least one subharmonic.

27. The method of claim 26, wherein the adjustment of the one or more switches connects or disconnects one or more filter circuits to modulate the one or more harmonics or subharmonics.

28. The method of claim 27, wherein the one or more filter circuits comprises a first filter circuit configured to filter a first harmonic of the one or more harmonics or a first subharmonic of the one or more subharmonics and a second filter circuit configured to filter a second harmonic of the one or more harmonics or a second subharmonic of the one or more subharmonics.

29. The method of claim 26, wherein the adjustment of the one or more switches controls an amount of power of the signal to be reflected at the one or more harmonics or subharmonics.

30. An apparatus for communicating with a wireless power transmitter, the apparatus comprising:
means for receiving power from a wireless charging field generated by the wireless power transmitter at a fundamental frequency;
means for switching configured to control an amount of power of at least one harmonic or subharmonic of the fundamental frequency for a signal to be reflected to the wireless power transmitter, the at least one harmonic or subharmonic representative of a symbol; and
means for generating the reflected signal to transmit the symbol to the wireless power transmitter.
